(19) United States
(12) Patent Application Publication
(10) Pub. No.: US 2019/0169027 A1
(43) Pub. Date: Jun. 6, 2019

(54) ROD-SHAPED MESOPOROUS CARBON NITRIDE MATERIALS AND USES THEREOF

(71) Applicant: SABIC Global Technologies B.V., Bergen op Zoom (NL)

(72) Inventors: Kripal S. Lakhi, Mawson Lakes (AU); Khalid Albahily, Thuwal (SA); Ugo Ravon, Thuwal (SA); Ajayan Vinu, Mawson Lakes (AU)

(21) Appl. No.: 16/326,980

(22) PCT Filed: Aug. 18, 2017
(86) PCT No.: PCT/IB2017/055017

§ 371 Date: Feb. 21, 2019

Related U.S. Application Data
(60) Provisional application No. 62/377,857, filed on Aug. 22, 2016.

(51) Int. Cl. C01B 21/06; B01D 53/04

(52) U.S. Cl. CPC C01B 21/0605; B01D 53/04; C01P 2006/12; C01P 2006/14; C01P 2006/16; B01D 2257/504; C01P 2002/72; C01P 2004/03; C01P 2004/04; B01D 2253/10; C01P 2004/12

(57) ABSTRACT

Methods of producing rod-shaped mesoporous carbon nitride (MCN) materials are described. The method includes (a) obtaining a template reactant mixture comprising an uncalcined rod-shaped SBA-15 template, a carbon source compound, and a nitrogen source compound; (b) subjecting the template reactant mixture to conditions suitable to form a rod-shaped template carbon nitride composite; (c) heating the rod-shaped template carbon nitride composite to a temperature of at least 500° C. to form a rod-shaped mesoporous carbon nitride material/SB A-15 (MCN-SBA-15) complex; and (d) removing the SBA-15 template from the MCN-SBA-15 complex to produce a rod-shaped mesoporous carbon nitride material.

### CROSS REFERENCE TO RELATED APPLICATIONS

This application claims the benefit of priority of U.S. Provisional Patent Application No. 62/377,857 filed Aug. 22, 2016, which is hereby incorporated by reference in its entirety.

### BACKGROUND

### 1. Field of the Invention

The invention generally concerns methods of producing rod-shaped mesoporous carbon nitride (MCN) materials from uncalcined rod-shaped SBA-15 templates, a carbon source and a nitrogen source.

### 2. Description of Related Art

Carbon dioxide (CO₂) is a product produced primarily through combustion of fossil fuel and constitutes a large portion of the total greenhouse gases. Efforts to capture, store, and use the CO₂ have been a focus of commercial, governmental, and research activities. A number of different methods such as absorption in liquid amines, cryogenic distillation, membrane purification and inorganic solid adsorbents have been employed to reduce CO₂ emissions from large-scale stationary point sources such as fossil fuel based power plants. Among these, absorption in liquid amines such as monoethanolamine, diethanolamine and methyldiethanol amine is the most common method; however adsorption suffers from serious disadvantages such as a high regeneration cost, corrosion of equipment, loss of solvent and flow related issues among others.

Adsorption based CO₂ capture processes have been investigated because of their low cost, non-corrosive nature and higher selectivity for CO₂ in a mixture of gases. It has been found that porous materials because of their high surface area and large pore volume have enormous potential as inorganic solid adsorbents for CO₂ uptake. Porous carbon materials can be suitable for adsorption applications because of their chemical and thermal stability, high surface area, economical and simple preparation, and economical regeneration. However, porous carbon materials suffer from serious drawbacks such as low adsorption capacity attributed to weaker interaction between CO₂ adsorbate and adsorbent, which in turn is because of the hydrophobic nature and neutral surface charge. A large number of amine-functionalized mesoporous silica materials with large pores, high surface and pore volume have also been tried as adsorbents for CO₂. By way of example, Lakhi et al. (RSC Advances, 2015, 5, 40183-4019) describes large pore (e.g., 9.12 to 11.2 nm) calcined SBA-15 silica templated carbon nitrides for capturing CO₂. In another example, Japanese Patent No. 2010-030844 describes using calcined SBA-15 templates to make MCN materials. In yet another example, Li et al. (Materials, 2013, 6, 981-999) describes amine grafted adsorbents produced by grafting amines on ethanol extracted SBA-15 silica materials. Amine-grafted adsorbents suffer for various reasons. First, amine based processes can involve highly corrosive and expensive amines, which render the equipment inoperable and involve high regeneration and maintenance costs. Secondly, grafted adsorbents can undergo deamination. Thirdly, grafting with amines can affect the textural properties of the materials especially, the surface area, pore volume and pore diameter as the amine molecules sit inside the pore channels thereby blocking access to the pores and result in increased diffusional resistance.

In addition to the above-described problems, many of the aforementioned process to make carbon nitride materials suffer in that they are energy inefficient and time intensive.

### SUMMARY

A discovery has been made that addresses the problems associated with preparation of carbon nitride materials for carbon dioxide sequestration. The discovery is premised on an energy efficient calcination-free route to prepare mesoporous carbon nitride materials (MCN). Notably, the carbon nitride materials can be made using an uncalcined template, thereby providing an elegant process to prepare carbon nitride materials in a more energy efficient (e.g., heat is not required to produce the template) and less time intensive (e.g., long calcination times are not required) manner. Notably, the silica templates were synthesized with different pore diameters without taking recourse to an extremely expensive and energy intensive high temperature calcination step. The pore size of the replicated mesoporous carbon nitride materials can also be varied from 2 nm to 6 nm without requiring any additional steps. The resulting MCN materials can have high structural integrity and withstand high pressure without causing any structural damage. MCN materials of the present invention have the same or similar CO₂ adsorption capacity as MCN materials prepared using calcined silica templates. Without wishing to be bound by theory, it is believed that the CO₂ adsorption capability of the MCN materials of the present invention is due to a higher surface area, pore volume, highly ordered structure and long range mesoporosity besides the inherent basic functional sites such as —NH and —NH₂ groups which contribute to anchoring the acidic CO₂ gas molecules to the surface of the MCN materials. Further, MCN materials of the present invention can be efficiently regenerated and reused without any significant change in their CO₂ uptake behavior. The process of the present invention provides an elegant way to tune the number of basic sites (e.g., nitrogen content) and generate a large number of micropores, which in turn contribute to a high surface area.

In a particular aspect of the invention, a method of producing a rod-shaped mesoporous carbon nitride (MCN) material is described. The method can include (a) obtaining a template reactant mixture that includes an uncalcined rod shaped SBA-15 template, a carbon source compound (e.g., carbon tetrachloride), and a nitrogen source compound (e.g., ethylene diamine); (b) subjecting the template reactant mixture to conditions suitable to form a rod-shaped template carbon nitride composite; (c) heating the rod-shaped template carbon nitride composite to a temperature of at least 500° C. to form a rod shaped mesoporous carbon nitride material/SBA-15 (MCN-SBA-15) complex; and (d) removing the SBA-15 template from the MCN-SABA-15 complex to produce a rod-shaped mesoporous carbon nitride material. Conditions to effect formation of the rod-shaped template carbon nitride composite can include heating (e.g., refluxing) the reaction mixture at a temperature of 80 to 100° C., preferably, 90° C. The temperature in step (b) can be attained by increasing the temperature in 10° C. increments up to 90° C. Heating in step (c) can be performed under an inert gas flow (e.g., nitrogen, argon, helium flow of 40 to 60 mL per minute). In some embodiments, the morphology of the rod-shaped template carbon nitride composite is substantially unchanged after heating at 500° C. or more. In certain embodiments, heating the rod-shaped template carbon nitride composite at a temperature of about 600° C. to 1100° C. can result in a carbon nitride material having a surface area of 650 to 790 m³ g⁻¹, a pore diameter of 2.0 to 6.0 nm, a pore volume of 0.4 to 1.5 cm³ g⁻¹, and a surface nitrogen content of 2.5 to 17.0% after removal of the template material. In some embodiments, heating the rod-shaped template carbon nitride composite at a temperature of about 900° C. can result in a carbon nitride material having a surface area of 650 to 790 m³ g⁻¹, a pore diameter of 4.0 to 4.5 nm, a pore volume of 0.7 to 1.5 cm³ g⁻¹, and a surface nitrogen content of 2.5 to 17.0% after removal of the template material. The uncalcined SBA-15 template can be performed by contacting the mesoporous carbon nitride material/SBA-15 complex with a hydrofluoric acid solution. The uncalcined rod-shaped SBA-15 template can be prepared by (a) reacting a polymerization solution comprising amphiphilic triblock copolymer and tetraethyl orthosilicate (TEOS) at a predetermined reaction temperature (e.g., 100° C. to 150° C., or 130° C.) to form a SBA-15 template, wherein the predetermined reaction temperature determines the pore size of the SBA-15 template; (b) extracting the amphiphilic triblock copolymer with ethanol at room temperature; and (c) drying the SBA-15 template to form an uncalcined SBA-15 template.

In another aspect of the invention, a carbon dioxide sequestration process is described. The CO₂ sequestration process can include contacting the mesoporous carbon nitride material produced by any of the methods of the present invention with a carbon dioxide containing fluid or gas and adsorbing the CO₂. Contacting conditions can include a temperature of 0° C. to 30° C. and a pressure of 0.1 to 3 MPa.

Other embodiments of the invention are discussed throughout this application. Any embodiment discussed with respect to one aspect of the invention applies to other aspects of the invention as well and vice versa. Each embodiment described herein is understood to be embodiments of the invention that are applicable to all aspects of the invention. It is contemplated that any embodiment discussed herein can be implemented with respect to any method or composition of the invention, and vice versa. Furthermore, compositions made by the methods of the invention can be used to achieve methods of the invention.

The use of the words “a” or “an” when used in conjunction with any of the terms “comprising,” “including,” “containing,” or “having” in the claims or the specification may mean “one,” but it is also consistent with the meaning of “one or more,” “at least one,” and “one or more than one.”

The terms “about” or “approximately” are defined as being close to as understood by one of ordinary skill in the art. In one non-limiting embodiment, the terms are defined to be within 10%, preferably within 5%, more preferably within 1%, and most preferably within 0.5%.

The use of the term “or” in the claims is used to mean “and/or” unless explicitly indicated to refer to alternatives only or the alternatives are mutually exclusive, although the disclosure supports a definition that refers to only alternatives and “and/or.”

The term “substantially” and its variations are defined to include ranges within 10%, within 5%, within 1%, or within 0.5%.

The terms “inhibiting” or “reducing” or “preventing” or “avoiding” or any variation of these terms, when used in the claims and/or the specification includes any measurable decrease or complete inhibition to achieve a desired result.

The term “effective,” as that term is used in the specification and/or claims, means adequate to accomplish a desired, expected, or intended result.

The terms “wt. %”, “vol. %”, or “mol. %” refers to a weight percentage of a component, a volume percentage of a component, or molar percentage of a component, respectively, based on the total weight, the total volume of material, or total moles, that includes the component. In a non-limiting example, 10 grams of component in 100 grams of the material is 10 wt. % of component.

As used in this specification and claim(s), the words “comprising” (and any form of comprising, such as “comprise” and “comprises”), “having” (and any form of having, such as “have” and “has”), “including” (and any form of including, such as “includes” and “include”) or “containing” (and any form of containing, such as “contains” and “contain”) are inclusive or open-ended and do not exclude additional, unrecited elements or method steps.

The processes and carbon nitride materials of the present invention can “comprise,” “consist essentially of,” or “consist of” particular ingredients, components, compositions, etc. disclosed throughout the specification. With respect to the transitional phase “consisting essentially of,” in one non-limiting aspect, a basic and novel characteristic of the process of the present invention is the energy-efficient production of a carbon nitride material for carbon dioxide sequestration.

Other objects, features and advantages of the present invention will become apparent from the following detailed description. It should be understood, however, that the detailed description and the specific examples, while indicating specific embodiments of the invention, are given by way of illustration only, since various changes and modifications within the spirit and scope of the invention will become apparent to those skilled in the art from this detailed description.

### DESCRIPTION OF THE DRAWINGS

The following drawings form part of the present specification and are included to further demonstrate certain aspects of the present invention. The invention may be better understood by reference to one or more of these drawings in combination with the detailed description of the specification embodiments presented herein. The drawings may not be to scale.

FIG. 1 is a schematic a CO₂ sequestration system using the rod-shaped MCN material of the present invention.

FIG. 2 shows the low angle powder XRD patterns for the solvent ethanol washed uncalcined (SEW) mesoporous carbon nitride-SBA-15 (MCN-1) SEW-MCN-1 prepared at various temperatures.

FIG. 3A shows the low angle powder XRD patterns of the SEW-SBA-15-X (X=100, 130 & 150° C.) of the present invention and inset shows the low angle XRD patterns for the calcined silica template SBA-15-X (X=100, 130 and 150° C.).

FIG. 3B shows the XRD patterns of SEW-MCN-1-X samples of the present invention and inset shows the low angle XRD patterns for the calcined silica template SBA-MCN-1 (X=100, 130, and 150° C.) prepared from the templates of FIG. 3A.

FIG. 4A shows the N₂ adsorption-desorption isotherms of the SEW-SBA-15-X (X=100, 130, and 150° C.).

FIG. 4B shows the N₂ adsorption-desorption isotherms of the SEW-MCN-1-X (X=100, 130, and 150° C.).

FIG. 4C shows the N₂ adsorption-desorption isotherms of the uncalcined-MCN-1-130-T (T=600 to 1100° C.).

FIG. 5 shows the variation of pore volume and BET surface areas of the SEW-MCN-1-X-T of the present invention with various carbonization temperatures.

FIG. 6A(a-c) shows the HR-SEM images of the SEW-SBA-15-X samples of the present invention. 6(a) SEW-SBA-15-100, 6(b) SEW-SBA-15-130, 6(c)

FIG. 6A(d-e) shows the HR-SEM images of the corresponding carbon nitride of FIG. 6A(a-c). SEW-SBA-15-150, 6(d) SEW-MCN-1-100, 6(e) SEW-MCN-1-130, and 6(f) SEW-MCN-1-150.

FIG. 6B shows the HR-SEM images of the SEW-MCN-1-130-T (T=600 to 1100° C.) samples of the present invention.

FIG. 7A(a-f) shows the low and high resolution TEM images of the SEW-MCN-1-X samples. 7(a,b) SEW-MCN-1-100, 7(c,d) SEW-MCN-1-130, 7(e,f) SEW-MCN-1-150.

FIG. 7B shows the HR-TEM images of the SEW-MCN-130-600, -700, -800, -900, -1000, -1100 samples of the present invention.

FIG. 8 shows the variation of C and N surface atomic composition of the SEW-MCN-130 sample of the present invention with carbonization temperature.

FIG. 9 shows the curve-fitted N1s spectra are displayed in FIG. 9(a-f) for the SEW-MCN-1-130-T samples.

FIG. 10 shows the spectrum of SEW-MCN-1-130-600 sample of the present invention.

FIG. 11 shows the CO₂ adsorption isotherms for the SEW-MCN-1-130-T samples of the present invention at 273 K (about 0° C.) and up to 30 bar (3 MPa) pressure.

FIG. 12(a-f) shows the adsorption isotherms for each sample recorded at three different temperatures. FIG. 12(a) for SEW-MCN-1-130-600° C., 12(b) for SEW-MCN-1-130-700° C., 12(c) for SEW-MCN-1-130-800° C., 12(d) for SEW-MCN-1-130-900° C., 12(e) for SEW-MCN-1-130-1000° C., 12(f) for SEW-MCN-1-130-1100° C.

FIG. 13 shows variation of isosteric heat of adsorption with CO₂ loading for SEW-MCN-1-130-X samples.

FIG. 14 shows the CO₂ adsorption isotherms for SEW-MCN-1-X (X=100, 130 or 150° C.) samples recorded at about 0° C.

FIG. 15 shows CO₂ adsorption isotherms of 15(a) SEW-MCN-1-100, 15(b) SEW-MCN-1-130, and 15(c) SEW-MCN-1-150.

FIG. 16 shows the variation of isosteric heat of adsorption of SEW-MCN-1-T samples and their comparison with literature MCN-1-Xs samples and MCN-7-130.

FIG. 17 shows the dependence of CO₂ adsorption capacity of SEW-MCN-1-X samples on the BET surface area of the materials.

### DETAILED DESCRIPTION

A discovery has been made that provides an elegant energy-efficient, and cost effective process to produce mesoporous carbon nitride material having the appropriate characteristics for CO₂ sequestration. The discovery is premised on a preparation method that produces uses an uncalcined rod-shaped silica template with readily available starting materials to produce rod-shaped MCN materials having suitable surface area, pore diameters and activity to capture CO₂ from a liquid or gas stream. In certain aspects, the tuning of the mesoporous CN material can be accomplished by controlling the carbonization temperature of the process.

These and other non-limiting aspects of the present invention are discussed in further detail in the following sections with reference to the Figures.

A. Process to Prepare an MCN Material from an Uncalcined Template

The MCN material can be formed by using a hard templating agent. A hard template can be a mesoporous silica. In one aspect, the mesoporous silica can be an uncalcined SBA-15 silica material or derivatives thereof.

1. Process to Prepare an Uncalcined Template

The uncalcined silica template can be synthesized under static conditions using a soft templating approach under highly acidic conditions. The templating agent can be a polymeric compound such as an amphiphilic triblock copolymer of ethylene oxide and propylene oxide having various molecular weights. A commercially available amphiphilic triblock copolymer templating agent is available from BASF (Germany) and sold under the trade name Pluronic P-123 (e.g., EO₂₀PO₇₀EO₂₀). The silica source can be any suitable silica containing compounds such as sodium silicate, tetramethyl orthosilicate, silica water glass, etc. A non-limiting example of the silica source is tetraethyl orthosilicate (TEOS), which is available from various commercial suppliers (e.g., Sigma-Aldrich®, U.S.A.). An aqueous solution of soft templating agent (e.g., the amphiphilic triblock copolymer) can be prepared by adding the soft templating agent to water and stirring the aqueous solution at 20 to 30° C., 23 to 27° C., or 25° C. until the reaction mixture is homogeneous (e.g., 3 to 5 hour). Aqueous mineral acid (e.g., 2 M HCl) can be added to the templating solution to obtain a solution having a pH of 2 or less. After addition of the acid, the temperature of the templating solution can be increased to 35 to 50° C., or 40° C. and agitated for a desired amount of time (e.g., 1 to 5 hours, or 2 hours). The silica source (e.g., TEOS) can be added under agitation to the templating solution for a desired amount of time (e.g., 10 to 30 minutes) and then held (incubated) without agitation for 24 hours to form the polymerization solution containing the soft templating agent and the silica source. The polymerization solution can be reacted under hydrothermal reaction conditions to form a silica template for a desired amount of time (e.g., 40 to 60 hours, or 45 to 55 hours, or 48 hours). In some embodiments, the reaction conditions can be autogenous conditions. A reaction temperature can range from 100° C. to 150° C., 110° C. to 140° C., 120° C. to 200° C., or any value or range there between (e.g., 101, 102, 103, 104, 105, 106, 107, 108, 109, 110, 111, 112, 113, 114, 115, 116, 117, 118, 119, 120, 121, 122, 123, 124, 125, 126, 127, 128, 129, 130, 131, 132, 133, 134, 135, 136, 137, 138, 139, 140, 143, 142, 143, 144, 145, 146, 147, 148, 149, 150, 151, 152, 153, 154, 155, 156, 157, 158, 159, 160, 161, 162, 163, 164, 165, 166, 167, 168, 169, 170, 171, 172, 173, 174, 175, 176, 177, 178, 179, 180, 181, 182, 183, 184, 185, 186, 187, 188, 189, 190, 191, 192, 193, 194, 195, 196, 197, 198, 199, or 200° C.). The reaction temperature can be used to tune the pore size of the silica template. By way of example, heating the reaction mixture to 100° C. under autogenous conditions for about 48 h can result in a silica template having a pore size of about 9.12 nm. Increasing the temperature from 100° C. to 130° C. can result in a 10 to 15% increase in pore size (e.g., to 10.5 nm). As the temperature is increased to 150° C., the pore size is further increased by 5 to 10% (e.g., to 11.2 nm, or an overall increase of 15 to 20%, or 18%). Wall thickness of the silica template can also be tuned by the reaction temperature. By way of example, higher reaction temperatures can produce thinner walls.

The silica template can be separated from the polymerization solution using known separation methods (e.g., gravity filtration, vacuum filtration, centrifugation, etc.) and washed with water to remove any residual polymeric solution. In a particular embodiment, the template is filtered hot. The filtered silica template can be dried to remove the water. By way of example, the filtered silica template can be heated at 90 to 110° C. until the silica template is dry (e.g., 6 to 8 hours). The dried filtered silica template can be extracted with alcohol (e.g., ethanol, methanol, propanol, etc.) at 20 to 30° C. (e.g., room temperature and in the absence of external heating or cooling) to remove any residual soft templating agent (e.g., copolymer and/or polymerized material). In a non-limiting example, the dried filtered silica template can be repeatedly agitated in fresh ethanol solutions until at least 80%, at least 90%, at least 92%, at least 95%, or at least 100% of the templating agent is removed. The ethanol extracted silica template can be dried to remove the alcohol and form a dried rod-shaped uncalcined silica template. In a particular embodiment, the uncalcined silica template is rod-shaped uncalcined mesoporous SBA-15 silica. The SBA-15 silica template can have a pore diameter ranging from 7 nm to 13 nm, 8 nm to 12 nm, or 7 nm, 7.1 nm, 7.2 nm, 7.3 nm, 7.4 nm, 7.5 nm, 7.6 nm, 7.7 nm, 7.8 nm, 7.9 nm, 8 nm, 8.1 nm, 8.2 nm, 8.3 nm, 8.4 nm, 8.5 nm, 8.6 nm, 8.7 nm, 8.8 nm, 8.9 nm, 9 nm, 9.1 nm, 9.2 nm, 9.3 nm, 9.4 nm, 9.5 nm, 9.6 nm, 9.7 nm, 9.8 nm, 9.9 nm, 10 nm, 10.1 nm, 10.2 nm, 10.3 nm, 10.4 nm, 10.5 nm, 10.6 nm, 10.7 nm, 10.8 nm, 10.9 nm, 11 nm, 11.1 nm, 11.2 nm, 11.3 nm, 11.4 nm, 11.5 nm, 11.6 nm, 11.7 nm, 11.8 nm, 11.9 nm, 12 nm, 12.1 nm, 12.2 nm, 12.3 nm, 12.4 nm, 12.5 nm, 12.6 nm, 12.7 nm, 12.8 nm, 12.9 nm, or any value there between. A wall thickness of the SBA silica template can range from 0.1 to 3 nm, or 0.3 to 2.8 nm, or 0.1, 0.2, 0.3, 0.4, 0.5, 0.6, 0.7, 0.8, 0.9, 1.0, 1.1, 1.2, 1.3, 1.4, 1.5, 1.6, 1.7, 1.8, 1.9, 2.0, 2.1, 2.2, 2.3, 2.4, 2.5, 2.6, 2.7, 2.8, 2.9 or 3.0 nm or any value there between.

2. Process to Prepare an MCN Material

The rod-shaped MCN material can be prepared using the uncalcined silica template (e.g., rod-shaped uncalcined SBA-15) described above and throughout the specification. The silica template pores can be filled corresponding carbon nitride precursor material(s) to form a template/carbon nitride precursor material. By way of example, the uncalcined SBA-15 silica material can be added to a solution of a carbon source (e.g., carbon tetrachloride) and a nitrogen source (e.g., ethylenediamine). Other carbon precursors that can be used are chloroform, dichloromethane, melamine, and methyl chloride. Other nitrogen sources such as propylene diamine, aniline, and other aliphatic primary diamines can also be used. The template/carbon nitride precursor material can subjected to conditions suitable to form a carbon nitride composite having the shape of the template (e.g., rod shaped). The reaction conditions can include a temperature of 80 to 100° C., or 85 to 95° C., or about 81° C., 82° C., 83° C., 84° C., 85° C., 86° C., 87° C., 88° C., 89° C., 90° C., 91° C., 92° C., 93° C., 94° C., 95° C., 96° C., 97° C., 98° C., 99° C. or 100° C., or any value there between. In some embodiments, the solution is refluxed under constant agitation for 5 to 8 hours, or 6 hours. The reaction conditions can also include heating the solution to 60° C., and then increasing the temperature in at 10 degree increments until reflux occurs (e.g., a temperature of about 80 to 100° C.) At these conditions, the carbon source and the nitrogen source react inside the pore of the material to form a template/CN composite. The template/CN composite can be separated from the solution using known separation methods (e.g., distillation, evaporation, filtration, etc.). By way of example, the solution can be removed from the template/CN composite by evaporating the solution under vacuum. The resulting template/CN composite can be dried, and then reduced in size with force (e.g., crushed). Drying temperatures can range from 90 to 110° C., or 100° C.

The dried template/CN composite can be subjected to conditions sufficient to carbonize the material and form a mesoporous carbon nitride material/template complex (e.g., SBA-15 (MCN-SBA-15) complex). Carbonizing conditions can include a heating the template/CN composite to a temperature of at least 500° C., at least 600° C., at least 700° C., at least 800° C., at least 900° C., at least 1000° C., or 1100° C. Notably, the rod-shape of the material does not change during carbonization. The nitrogen properties and textural properties of the MCN material can be tuned by using a specific carbonization temperature. By way of example, the pore diameter of the resulting MCN material can increase with increasing carbonization temperature up to 900° C. At a temperature of 900° C. or more, the textural properties become saturated and remain substantially unchanged. Nitrogen content can be also be tuned by varying the carbonization temperature. With increasing carbonization temperature, there can be a progressive increase in the C atomic % while there a proportional decrease in the N atomic %. Without wishing to be bound by theory, it is believed that at higher temperatures, N tends to escape from the system by breaking bonds. By way of example, a template/CN composite heated at 600° C. can have an N atomic % of about 16%, and after heating at 1100° C. have a N atomic % of about 3%. The carbon content can also be tuned based on a selected temperature as the atomic carbon content increases as the temperature rises. By selecting a desired carbonization temperature, the C/N atomic ratio of the mesoporous carbon nitride material of the present invention can be tuned. By way of example, a carbonization of 600° C. can result in an atomic C/N ratio of about 5:1, a carbonization temperature of 800° C. can result an atomic C/N ratio of about 9:1, and a carbonization temperature of 1000° C. can result in an atomic C/N ratio of about 23:1. In one particular embodiment, a carbonization temperature of 850° C. provides an atomic C/N ratio of 9:1 to 10:1, or 9.5:1 to 9.8:1, or 9.6:1.

The template can be removed from the carbonized material (e.g., the mesoporous carbon nitride material/template complex) by subjecting it to conditions sufficient to dissolve the template, and form the mesoporous carbon nitride material of the present invention. By way of example, the template can be dissolved using an HF treatment, a very high alkaline solution, or any other dissolution agent capable of removing the template and not dissolving the CN framework. The kind of template and the CN precursor used influence the characteristics of the final material. The resulting rod-shaped MCN material of the present invention can be washed with solvent (e.g., ethanol) to remove the dissolution material, and then dried (e.g., heated at 100° C.).

### B. Mesoporous Carbon Nitride Materials

The rod-shaped MCN material can have a pore size or pore diameter of 1 nm, 2 nm, 3 nm, 4 nm, 5 nm, 6 nm, or 7 nm. Specifically the pore size can range from 2 to 7 nm, preferably 2 to 6 nm, or about 2, 2.1, 2.2, 2.3, 2.4, 2.5, 2.6, 2.7, 2.8, 2.9, 3.0, 3.1, 3.2, 3.3, 3.4, 3.5, 3.6, 3.7, 3.8, 3.9, 4.0, 4.1, 4.2, 4.3, 4.4, 4.5, 4.6, 4.7, 4.8, 4.9. 5.0, 5.1, 5.2, 5.3, 5.4, 5.5, 5.6, 5.7, 5.8, 5.9, or 6.0 nm. The pore volume of the mesoporous material can range from 0.4 to 1.1 cm³g⁻¹ or any value or range there between (e.g., 0.40, 0.41, 0.42, 0.43, 0.5, 0.51, 0.52, 0.53, 0.54, 0.55, 0.56, 0.57, 0.58, 0.59, 0.60, 0.61, 0.62, 0.63, 0.64, 0.65, 0.67, 0.68, 0.69, 0.70, 0.71, 0.72, 0.73, 0.74, 0.75, 0.76, 0.77, 0.78, 0.79, 0.80, 0.81, 0.82, 0.83, 0.84, 0.85, 0.86, 0.87, 0.88, 0.89, 0.9, 0.91, 0.92, 0.93, 0.94, 0.95, 0.96, 0.97, 0.98, 0.99, 1.0, or 1.1 cm³g⁻¹). Preferably, the pore volume is 0.72 to 1.02 cm³g⁻¹. A surface area of the MCN can be from 590 to 790 m²g⁻¹ or 600 to 700 m²g⁻¹, 650 to 750 m²g⁻¹, or about 590, 600, 610, 615, 620, 625, 630, 635, 640, 645, 650, 655, 660, 665, 670, 675, 680, 685, 690, 695, 700, 710, 715, 720, 725, 730, 735, 740, 745, 750, 755, 760, 765, 770, 775, 780, 785, or 790 m²g⁻¹. A surface atomic nitrogen content of the MCN material can range from 2.5 to 17%, or 5% to 15%, or 8% to 10%, or about 2.5, 3.0, 3.5, 4.0, 4.5, 5.0, 5.5, 6.0, 6.5, 7.0, 7.5, 8.0, 8.5, 9.0, 9.5, 10.0, 10.5, 11.0, 11.5, 12.0, 12.5, 13.0, 13.5, 14.0, 14.5, 15.0, 15.5, 16.0, 16.5, or 17%. A surface atomic carbon content of the MCN material can range from 80 to 95%, 85 to 90%, or about 80, 81, 82, 83, 84, 85, 86, 87, 88, 89, 90, 91, 92, 93, 94, 95%. The balance of the MCN material can include oxygen, silicon, fluoride, or a combination thereof. In a preferred embodiment, silicon and fluoride. In certain aspects the mesoporous material can have a carbon to nitrogen (C:N) ratio of 5:1 to 39:1, 8:1 to 25:1, or 10:1 to 15:1 or about 5:1, 6:1, 8:1, 10:1, 23:1, 25:1, 30:1, 35:1, or 38:1. In some embodiments, a rod-shaped CN material made from a silica template prepared at 100 to 150° C. can have a pore diameter 2.0 to 6.0 nm, of surface area of 650 to 790 m³g⁻¹, and a surface atomic nitrogen content of 2.5 to 17.0%. In another embodiment a rod-shaped CN material made from a silica template prepared at 130° C., a rod-shaped CN material can have a pore diameter of 4.0 to 4.5 nm, a surface area of 650 to 790 m³g⁻¹, and a surface atomic nitrogen content of 2.5 to 17.0%. In some embodiments, a rod-shaped CN material made from a silica template prepared at 130° C. and carbonized at 800 to 900° C. can have a pore diameter 4.3 to 4.6 nm, of surface area of 730 to 740 m³g⁻¹, a surface atomic nitrogen content of 10% to 6.0%, a surface atomic carbon content of 86% to 90%, with the balance being atomic oxygen.

### C. Use of the Mesoporous Carbon Nitride Materials

The rod-shaped MCN materials can be used in applications for sequestration of carbon dioxide. Certain embodiments of the invention are directed to systems for CO₂ sequestration, capture and then release.

According to one embodiment of the present invention, a process for CO₂ capture is described. In step one of the process, a feed stock comprising CO₂ is contacted with MCN. The feed stock can include a concentration of CO₂ from 0.01 to 100% and all ranges and values there between (e.g., 0.01, 0.02, 0.03, 0.04, 0.05, 0.06, 0.07, 0.08, 0.09, 0.10, 0.11, 0.12, 0.13, 0.14, 0.15, 0.16, 0.17, 0.18, 0.19, 0.22, 0.21, 0.22, 0.23, 0.24, 0.25, 0.26, 0.27, 0.28, 0.29, 0.30, 0.31, 0.32, 0.33, 0.34, 0.35, 0.36, 0.37, 0.38, 0.39, 0.40, 0.41, 0.42, 0.43, 0.50, 0.51, 0.52, 0.53, 0.54, 0.55, 0.56, 0.57, 0.58, 0.59, 0.60, 0.61, 0.62, 0.63, 0.64, 0.65, 0.67, 0.68, 0.69, 0.70, 0.71, 0.72, 0.73, 0.74, 0.75, 0.76, 0.77, 0.78, 0.79, 0.80, 0.81, 0.82, 0.83, 0.84, 0.85, 0.86, 0.87, 0.88, 0.89, 0.90, 0.91, 0.92, 0.93, 0.94, 0.95, 0.96, 0.97, 0.98, 0.99, 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99, or 100%). The % of CO₂ in the feed stock can be measured in wt. % or mol. % or volume % based on the total wt. % or mol. % or volume % of the feed stock respectively. In a preferred aspect, the feedstock can be ambient atmospheric or a gas effluent from a CO₂ producing process. In one non-limiting instance, the CO₂ can be obtained from a waste or recycle gas stream (e.g., a flue gas emission from a power plant on the same site such as from ammonia synthesis or a reverse water gas shift reaction) or after recovering the carbon dioxide from a gas stream. A benefit of recycling carbon dioxide as a starting material can reduce the amount of carbon dioxide emitted to the atmosphere (e.g., from a chemical production site). The feedstock containing CO₂ can contain additional gas and/or vapors (e.g., nitrogen (N₂), oxygen (O₂), argon (Ar), chloride (Cl₂), radon (Ra), xenon (Xe), methane (CH₄), ammonia (NH₃), carbon monoxide (CO), sulfur containing compounds (RₓS), volatile halocarbons (all permutations of HFCs, CFCs, and BFCs), ozone (O₃), partial oxidation products, etc.). In some examples, the remainder of the feedstock gas can include another gas or gases provided the gas or gases are inert to CO₂ capture and/or activation for further reaction so they do not negatively affect the MCN material. In instances where another gas or vapor do have negative effects on the CO₂ capture process (e.g., conversion, yield, efficiency, etc.), those gases or vapors can be selectively removed by known processes. Preferably, the reactant mixture is highly pure and substantially devoid of water. In some embodiments, the CO₂ can be dried prior to use (e.g., pass through a drying media) or contain a minimal amount of water or no water at all. Water can be removed from the reactant gases with any suitable method known in the art (e.g., condensation, liquid/gas separation, etc.).

In a step 2 of the process, the reactant mixture is held (incubated) under conditions in which CO₂ is attached to the mesoporous material. For example, the CO₂ can be adsorbed to the mesoporous material or can covalently bind to a primary or secondary nitrogen group of the mesoporous material. The incubation conditions can include a temperature, pressure, and time. The temperature range for the incubation can be from 0° C. to 30° C., from 5° C. to 25° C., 10° C. to 20° C., and all ranges and temperatures there between. The pressure range for the incubation can be from 0.1 MPa to 3 MPa, or 1 to 2 MPa. In embodiments, where adsorption/desorption processes are used, the pressure of adsorption is higher than a pressure of desorption. By way of example, a gas including methane, hydrogen, or other less adsorbing gases, the adsorbing CO₂ partial pressure can range from 0.1 to 3 MPa and the desorbing CO₂ partial pressure can range from 0 MPa to 2 MPa. The time of incubation can be from 1 sec to 60 seconds, 5 minutes to 50 minutes, 10 minutes to 30 minutes. The conditions for CO₂ capture can be varied based on the source and composition of feed stream and/or the type of the reactor used.

According to another embodiment of the current invention, the MCN material containing attached CO₂, the CO₂ can be released to regenerate the MCN material and release CO₂. Without limitation, equilibrium binding between the MCN material and CO₂ can occur. In some aspects, an equilibrium binding constant can be determined and influenced by typical reaction condition manipulations (e.g., increasing the concentration or pressure of the reactant feed stock, etc.). The methods and system disclosed herein also include the ability to regenerate used/deactivated MCN in a continuous process. Non-limiting examples of regeneration include a pressure swing adsorption (PSA) process at a lower pressure and/or a using a change of feed material. In some embodiments, the MCN/CO₂ is disposed in an environmentally safe manner.

Certain embodiments of the invention are directed to systems for CO₂ capture. In general aspects, stage 1 of a system for CO₂ capture includes moving a flowing mass of ambient air having the usual relatively low concentration of CO₂ in the atmosphere, with a relatively low pressure drop (in the range of 100-1000) pascals. The flow of CO₂ containing air from Stage 1, can be passed, in Stage 2, through a large area bed, or beds, of sorbent (e.g., including MCN-TU) for the CO₂, the bed having a high porosity and on the walls defining the pores a highly active CO₂ adsorbent.

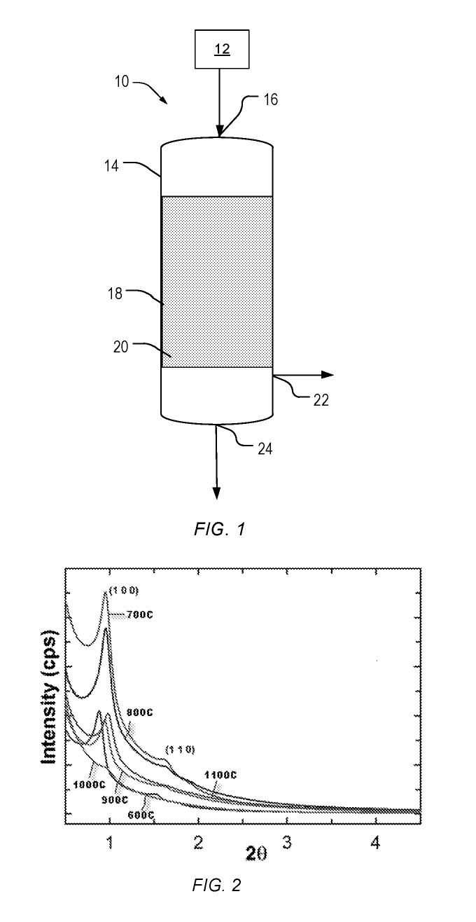

In general aspects, stage 1 of a system for CO₂ capture includes moving a flowing mass of ambient air having the usual relatively low concentration of CO₂ in the atmosphere, with a relatively low pressure drop (in the range of 100-1000) pascals. The flow of CO₂ containing air from can be passed through a large area bed, or beds, of sorbent (e.g., including MCN) for the CO₂, the bed having a high porosity and on the walls defining the pores a highly active CO₂ adsorbent. Referring to FIG. 1, system is illustrated, which can be used to capture CO₂ using the MCN material of the present invention. The system 10 can include a feed source 12 and a separation unit 14. The feed source 12 can be configured to be in fluid communication with the separation unit 14 via an inlet 16 on the separation unit. The feed source can be configured such that it regulates the amount of CO₂ containing material entering the separation unit 16. The separation unit 16 can include at least one separation zone 18 having the MCN material 20 of the present invention. Although not shown, the separation unit 12 may have additional inlets for the introduction of gases that can be added to the separation unit as mixtures or added separately and mixed within the separation unit. Optionally, these additional inlets may also be used as an evacuation outlet to remove and replace the atmosphere within the reactor with inert atmosphere or reactant gases in pump/purge cycles. To avoid the need to remove atmosphere from the separation unit, the entire separation unit can kept under inert atmosphere. The separation unit 14 can include an outlet 22 for uncaptured gases in the separation unit. The separation unit can be depressurized or chemically treated to remove the desorbed or bound CO₂ from the MCN material. Multiple units can be used in combination with separation unit 12 to provide a continuous process. The released CO₂ can exit the separation unit from outlet 24 and be collected, stored, transported, or provided to other processing units for further use.

### EXAMPLES

The following examples as well as the figures are included to demonstrate preferred embodiments of the invention. It should be appreciated by those of skill in the art that the techniques disclosed in the examples or figures represent techniques discovered by the inventors to function well in the practice of the invention, and thus can be considered to constitute preferred modes for its practice. However, those of skill in the art should, in light of the present disclosure, appreciate that many changes can be made in the specific embodiments which are disclosed and still obtain a like or similar result without departing from the spirit and scope of the invention.

Materials.

Tetraethyl orthosilicate (TEOS), carbon tetrachloride (CCl₄), ethylenediamine (EDA), and triblock copolymer poly(ethylene glycol)-block-poly(propylene glycol)-block-poly(ethylene glycol) (Pluronic P-123, molecular weight 5800 g mol⁻¹, EO₂₀PO₇₀EO₂₀) were obtained from Sigma-Aldrich® (U.S.A). Ethanol and hydrofluoric acid (HF) were purchased from Wako Pure Chemical Industries (U.S.A.). All the chemicals were used without further purification. Doubly deionized water has been used throughout the synthesis process.

### Example 1

### Synthesis of Rod-Shaped Mesoporous Silica Template, SBA-15

Pluronic P-123 (4.0 g) was added distilled water (30 g) and with stirring at room temperature for 4 hour followed by addition of HCl (120 g, 2 M) and simultaneously the temperature was raised to 40° C. The aqueous mixture was agitated for 2 hours and then TEOS (8.6 g) was added and the mixture was agitated for 20 minutes after which agitation was stopped and the mixture was held without agitation for 24 hours at a temperature of 40° C. The solution mixture was held at under autogenous conditions at 100° C., 130° C., or 150° C. for 48 hr depending on the desired pore diameter of the resulting product. The product was filtered hot and washed three times with water. The filtered product was dried in an oven at 100° C. for 6-8 hr, and then washed twice with ethanol, each time being stirred with ethanol for 3 hr at room temperature. The filtered sample was dried overnight before use to obtain the uncalcined SBA-15 sample 1-3 of the present invention (also designated as SEW-SBA-15-X, with SEW designating ethanol wash and X designating the temperature of the reaction).

### Example 2

### Synthesis of Rod-Shaped Mesoporous Carbon Nitride Material

General Procedure. SEW-SBA-15-X (0.5 g) was mixed with CCl₄ (3 g) and EDA (1.35 g) in reactor fitted with a water cooled condenser. The mixture was refluxed at 90° C. for 6 hr under constant stirring. The temperature was increased in steps of 10° C. from 60 to 90° C. After 6 hr, the unreacted CCl₄ and EDA in the composite polymer were removed using a rotary evaporated at 55° C. The sample was then dried at 100° C. for 6 hr, and then crushed into powder using a mortar and pestle. The crushed powder was carbonized in a tubular furnace at the desired temperature for 5 hr under nitrogen flow. The carbonized sample was treated with 5% HF and the sample was washed three times with excess ethanol and then kept for drying at 100° C. for 6 hr before characterization. Sample 4-6 were carbonized at 600° C. and designated as SEW-SBA-15-100, 130 and 150 (Samples 4-6). A series of MCN materials were prepared by changing the carbonization temperature from 600 to 1100° C. The samples were labelled as SEW-MCN-1-X-T (where T is the carbonization temperature, e.g., Samples 7-12) and SEW and X are abbreviated as above.

### Example 3

### Characterization of SEW-MCN-1-X-T and SEW-SBA-15

XRD:

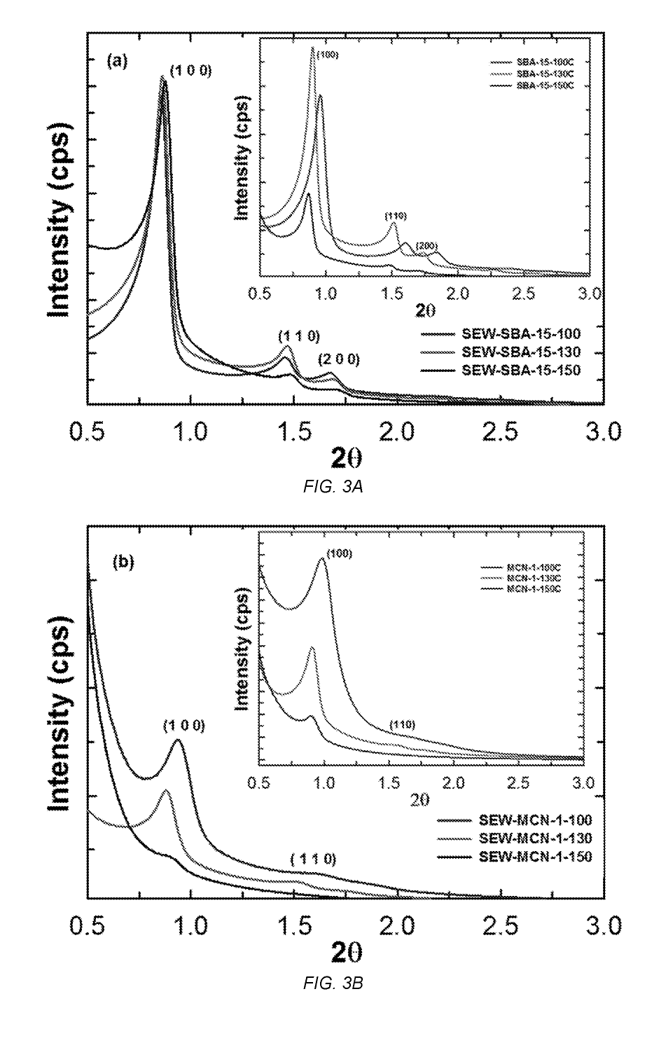

Powder XRD patterns were recorded on a Rigaku Ultima+(JAPAN) diffractometer using CuKα (λ=1.5408 Å) radiation. Low angle powder x-ray diffractograms were recorded in the 2θ range of 0.6-6° with a 2θ step size of 0.0017 and a step time of 1 sec. In case of wide angle X-ray diffraction, the patterns were obtained in the 20 range of 10-80° with a step size of 0.0083 and a step time of 1 sec. FIG. 2 shows the low angle powder XRD patterns for the SEW-MCN-1-130-T samples (T=600 to 1100° C.). FIG. 3A shows the low angle powder XRD patterns of the ethanol washed silica template prepared under static synthesis condition, SEW-SBA-15-X (X=100, 130 and 150° C.) and inset shows the low angle XRD patterns for the calcined silica template SBA-15-X (X=100, 130 and 150° C.) prepared under static synthesis conditions via conventional calcination route. FIG. 3B shows the XRD patterns of SEW-MCN-1-T samples prepared from SEW-SBA-15-X silica templates as a template via nanocasting technique.

Referring to FIG. 2, all the MCNs exhibit a higher order and few low order peaks with varying intensities. The sharp and prominent peaks are indexed as (100) reflection plane while the low order peaks are indexed as (110) reflection plan. Further, it can be seen that the effect of changing the carbonization temperature from 600° C. through 1100° C. was clearly reflected in the XRD patterns of these samples. As the carbonization temperature varied from 600° C. to 1100° C., the peak intensity showed a visible variation. The strength of the diffraction peaks were determined to be indicative of mesopore regularity and pore-wall density. For example, the peak intensity increased on increasing the temperature from 600 to 700° C. and then decreased trend as the temperature increased up to 1000° C. It was noted that the peak intensity for sample at 1100° C. was higher than that for the sample at 1000° C. This was unexpected as one would expect lower intensity for 1100° C. sample as compared to 1000° C. The changes in the structural order and peak intensities were attributed in part to the changing carbonization temperature.

Referring to FIG. 3A, all three silica templates SEW-SBA-15-T exhibited several low angle peaks which are indexed as (100), (110) and (200) reflection planes on a 2D hexagonal lattice with p6 mm symmetry. These peaks were determined to be characteristics of SBA-15 silica template of the literature. It was noted that as the synthesis temperature increased from 100° C. to 150° C., the peaks did not show a significant shift towards lower 2theta values, which was also reflected in the nearly same cell constants and d-spacing values for the three samples as presented in Table 1. More precisely, the d-spacing and cell constant values showed a decreasing trend with increasing hydrothermal synthesis temperature. This observation was quite contrary to comparative pore expanded SBA-15 silica templates prepared via typical calcination route shown in the insert. The difference in the XRD patterns of the ethanol washed SEW-SBA-15-T and calcined SBA-15-TC was attributed to the incomplete removal of the organic surfactant as calcination of as-synthesized mesoporous silica prepared via soft templating approach caused complete removal of the surfactant whereas ethanol extraction removed surfactant anywhere between 90-92%. The intensities of the diffraction peaks and peak positions were nearly same, suggesting that all the three materials have similar structural order, which was unexpected as an increase in hydrothermal treatment temperature results in partial loss of mesostructured, which is manifested in the form of reduced and different diffraction peak intensities. The XRD results indicate that the silica templates prepared by washing with ethanol have high structural order and the surfactant removal by dissolving in ethanol was successful and provides an alternative method for the synthesis of SBA-15 materials

As shown in FIG. 3B, all the three samples have one sharp peak and a low angle peak that were also present in the silicate template. This result confirmed that the SEW-MCN-1-X samples had ordered structure and the replication process from the silica template to the carbon nitride was successful. Similar results were obtained when SBA-15 prepared under static synthesis conditions via calcinations route was used as a template for the synthesis of comparative mesoporous carbon nitride materials using the procedure of Example 2. However, among the three comparative samples, the intensity for SEW-MCN-1-150 was very low indicating significant loss of structure due to the decomposition of the surfactant due to heat treatment at 150° C. Similarly, SEW-MCN-1-130 half a lower intensity compared to SEW-MCN-1-100. Interestingly, a comparison of the SEW-MCN-1-X samples of the present invention with carbon nitride prepared by conventional calcination route (MCN-1-X samples in inset FIG. 3B) showed a striking similarity in the XRD patterns which indicates that removal of organic surfactant by ethanol extraction was a viable method and produced mesoporous templates without significant aberration in the structure or textural properties.

Textural Parameters.

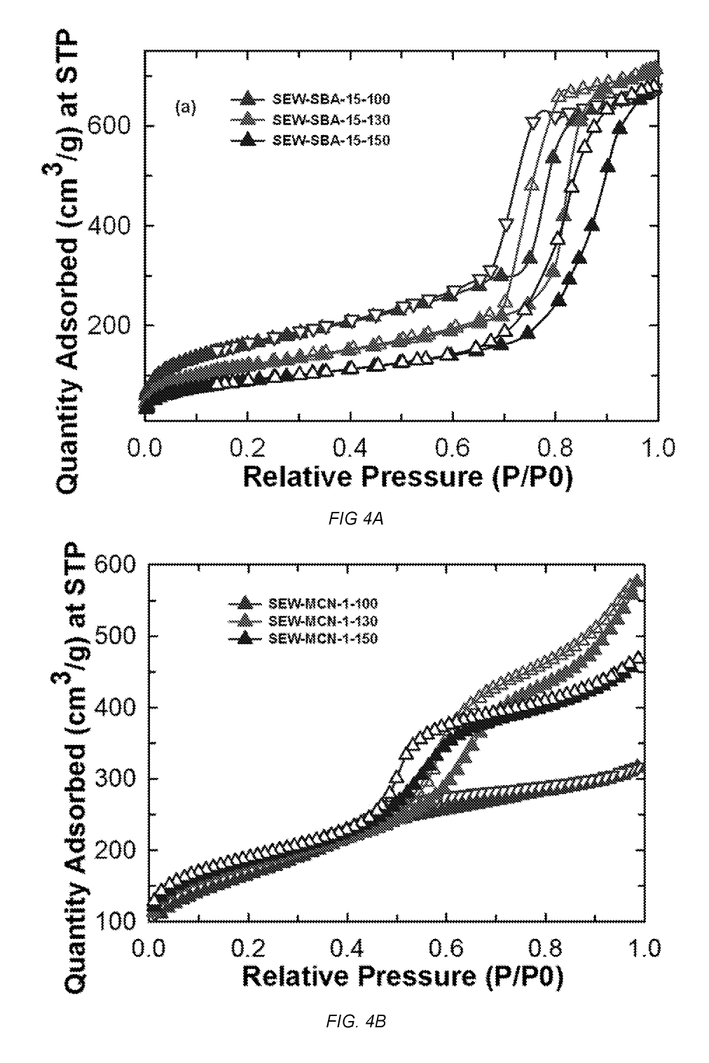

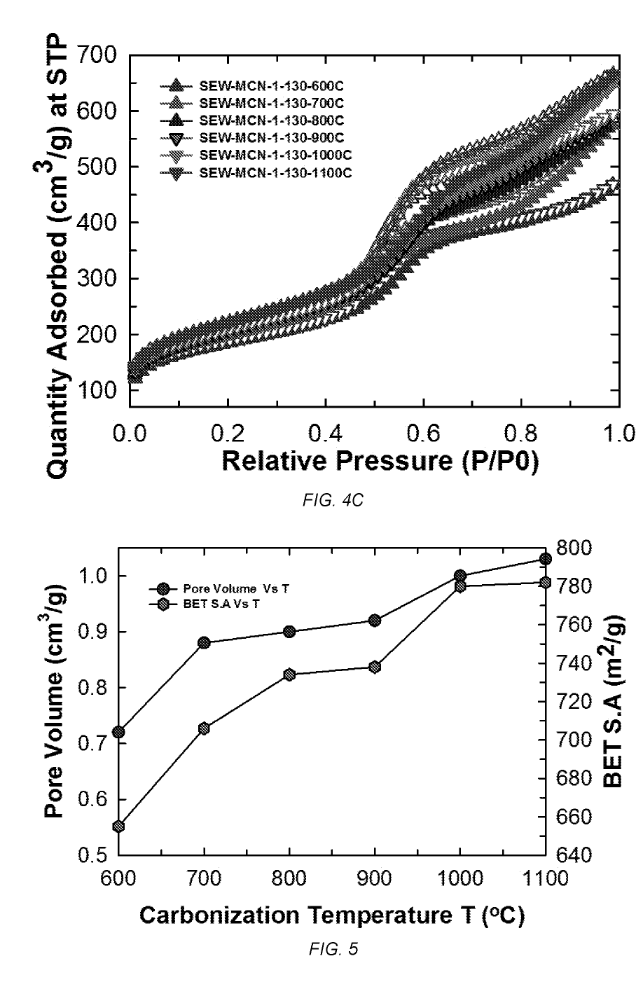

Textural parameters and mesoscale ordering of the MCN materials of the present invention was confirmed by nitrogen adsorption/desorption measurements using a Quantachrome Instruments (U.S.A.) sorption analyzer at −196° C. All samples were out-gassed for 12 hrs at high temperatures under vacuum (p<1×10-5 h·Pa) in the degas port of the adsorption analyzer. The specific surface area was calculated using the Brunauer-Emmett-Teller (BET) method. The pore size distributions were obtained from either adsorption or desorption branches of the isotherms using Barrett-Joyner-Halenda (BJH) method. FIG. 4A shows the N₂ adsorption-desorption isotherms of the SEW-SBA-15-X. FIG. 4B shows the N₂ adsorption-desorption isotherms of the SEW-MCN-1-X. FIG. 4C shows the N₂ adsorption-desorption isotherms of the SEW-MCN-1-130-T. Referring to FIGS. 4A-4C, the isotherms were of type IV according to IUPAC classification and with characteristic capillary condensation or evaporation step, which indicated the presence of a well-ordered mesoporous structure. The isotherms also exhibit H1 hysteresis loop typically associated with SBA-15 kind of silica template with uniform and cylindrical pores. Referring to FIGS. 4A and 4B, the shift in the capillary condensation step towards higher relative pressure was clearly evident with increase in the synthesis temperature from 100° C. to 150° C., which was attributed to an increase in pore diameter with increasing hydrothermal treatment temperature.

Tables 1 and 2 show the textural properties i.e., pore volume, pore diameter, and surface areas of the samples. Table 3 presents wall thickness of samples of the present invention calcined templates (SBA-15-100/130/150) and MCN made from calcined templates (MCN-1-100/130/150). The textural parameters of SEW-MCN-1-X samples are presented in Table 1. As expected, the pore diameter increased from 2.8 nm to 5.7 nm with the increase in the synthesis temperature of the silica template SEW-SBA-15-X. The BET surface area showed an increasing-decreasing trend and a similar trend was seen for micropore volume. The total pore volume however increased progressively with increasing hydrothermal synthesis temperature of the templates. Among the samples prepared, SEW-MCN-1-130 showed the highest surface area, highest micropore volume and a reasonable pore diameter and total pore volume. The other two samples SEW-MCN-1-100 and SEW-MCN-1-150 showed reduced textural properties. From these results, it was determined that successful replication of the mesoporous structure of the template SEW-SBA-15-T to the corresponding carbon nitride SEW-MCN-1-T.

Textural properties and CO₂ adsorption capacities of SEW-MCN-1-130-T samples are presented in Table 2. The pore diameters of all the samples were approximately the same and lied in the range of 4.4-4.9 nm with the samples carbonized at 1000° C. having the highest pore diameter of 4.9 nm. The pore volumes also showed an increasing trend as the carbonization temperature was increased from 600 to 1000° C. with the sample carbonized at 1000 and 1100° C. showing about the same pore volume. FIG. 5 shows the variation of pore volume and BET surface areas of the samples with various carbonization temperatures. All the samples showed an increasing trend with increase in carbonization temperature from 600 to 1000° C., however, the values of pore volume and surface areas were almost the same for samples carbonized at 1000 and 1100° C. Thus, it was determined that at about 1000° C., the textural properties became saturated and did not show any further increase with increase in carbonization temperature.

TABLE 1

| | | | | Micro | Meso | BET | | | | ^{b}CO₂ |
|---|---|---|---|---|---|---|---|---|---|---|
| Sample | Sample | aₒ | d | S.A | S.A | S.A. | PV_{micro} | PVₜₒₜₐₗ | PD^{a} | adsorbed |
| No. | Description | (nm) | (nm) | (m²/g) | (m²/g) | (m²/g) | (cm³/g) | (cm³/g) | (nm) | (mmol/g) |
| 1 | SEW-SBA- | 12.0 | 10.4 | 15 | 582 | 597 | — | 1.03 | 9.12 | 13.2 |
| | 15-100 | | | | | | | | | |
| 2 | SEW-SBA- | 11.7 | 10.2 | 14 | 421 | 435 | — | 1.10 | 10.5 | 10.2 |
| | 15-130 | | | | | | | | | |
| 3 | SEW-SBA- | 11.5 | 10.0 | 12 | 315 | 327 | — | 1.04 | 11.2 | 9.7 |
| | 15-150 | | | | | | | | | |
| 4 | SEW-MCN- | 10.9 | 9.46 | 39 | 557 | 596 | 0.013 | 0.49 | 2.8 | 11.6 |
| | 1-100 | | | | | | | | | |
| 5 | SEW-MCN- | 10.6 | 10.1 | 195 | 460 | 655 | 0.085 | 0.72 | 4.4 | 15.4 |
| | 1-130 | | | | | | | | | |
| 6 | SEW-MCN- | 11.8 | 10.3 | 178 | 460 | 638 | 0.077 | 0.89 | 5.7 | 13.0 |
| | 1-150 | | | | | | | | | |

^{a}Pore diameter calculated using the adsorption branch.
^{b}CO₂ adsorption isotherms recorded using pure and dry CO₂ at 0° C. and 30 bar.

TABLE 2

| Sam- | | | | PV | | BET | ^{b}CO₂ |
|---|---|---|---|---|---|---|---|
| ple | Sample | aₒ | d | (cm³/ | PD^{a} | S.A | Adsorbed |
| No. | Description | (nm) | (nm) | g) | (nm) | (m²/g) | (mmol/g) |
| 7 | SEW-MCN-1- | 11.6 | 10.1 | 0.72 | 4.4 | 655 | 15.4 |
| | 130-600 | | | | | | |
| 8 | SEW-MCN-1- | 10.8 | 9.4 | 0.88 | 4.2 | 705 | 17.4 |
| | 130-700 | | | | | | |
| 9 | SEW-MCN-1- | 10.7 | 9.32 | 0.91 | 4.4 | 735 | 17.2 |
| | 130-800 | | | | | | |
| 10 | SEW-MCN-1- | 10.9 | 9.48 | 0.92 | 4.5 | 738 | 20.1 |
| | 130-900 | | | | | | |
| 11 | SEW-MCN-1- | 11.3 | 9.84 | 1.00 | 4.9 | 780 | 18.4 |
| | 130-1000 | | | | | | |
| 12 | SEW-MCN-1- | 10.5 | 9.1 | 1.02 | 4.6 | 781 | 19.3 |
| | 130-1100 | | | | | | |

^{a}Pore diameter calculated using the adsorption branch.
^{b}CO₂ adsorption isotherms recorded using pure and dry CO₂ at 0° C. and 30 bar.

TABLE 3

| | | a₀ | PD | t* (a₀ − P_{D}) |
|---|---|---|---|---|
| Sample No. | Sample Description | (nm) | (nm) | (nm) |
| 13 | SBA-15-100** | 10.63 | 8.4 | 2.23 |
| 14 | SBA-15-130** | 11.32 | 11.25 | 0.07 |
| 15 | SBA-15-150** | 11.74 | 11.29 | 0.45 |
| 1 | SEW-SBA-15-100 | 12 | 9.12 | 2.88 |
| 2 | SEW-SBA-15-130 | 11.7 | 10.5 | 1.2 |
| 3 | SEW-SBA-15-150 | 11.5 | 11.2 | 0.3 |
| 16 | MCN-1-100** | 10.38 | 3.76 | 6.62 |
| 17 | MCN-1-130** | 11.16 | 4.99 | 6.17 |
| 18 | MCN-1-150** | 11.32 | 5.94 | 5.38 |
| 4 | SEW-MCN-1-100 | 10.9 | 2.8 | 8.1 |
| 5 | SEW-MCN-1-130 | 10.6 | 4.4 | 6.2 |
| 6 | SEW-MCN-1-150 | 11.8 | 5.7 | 6.1 |

*t calculated wall thickness for a hexagonal p6mm symmetry
**values of calcined materials obtained from Lakhi et al., RSC Advs, 2015 DOI 10.1039/C5RA04730G.

HR-SEM HR-TEM.

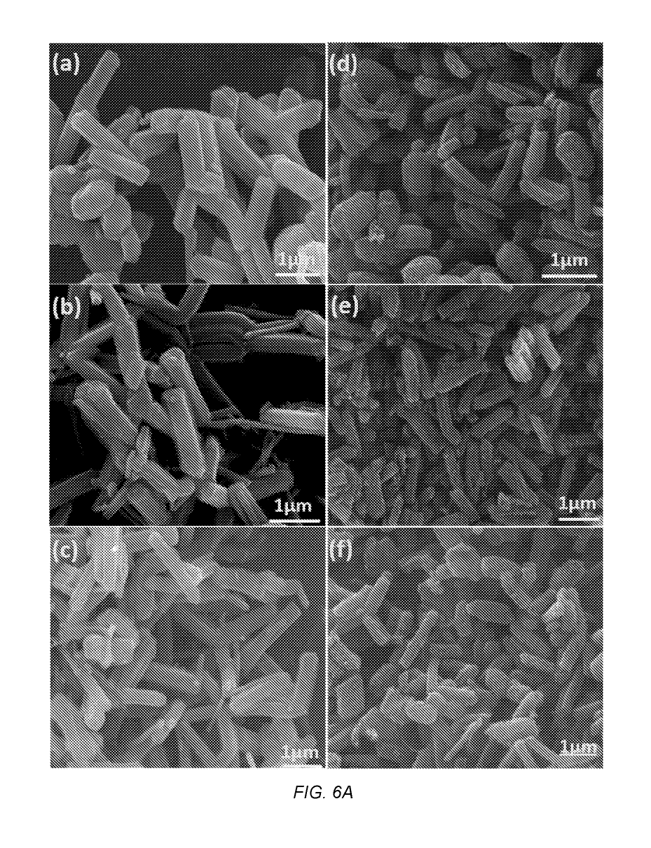

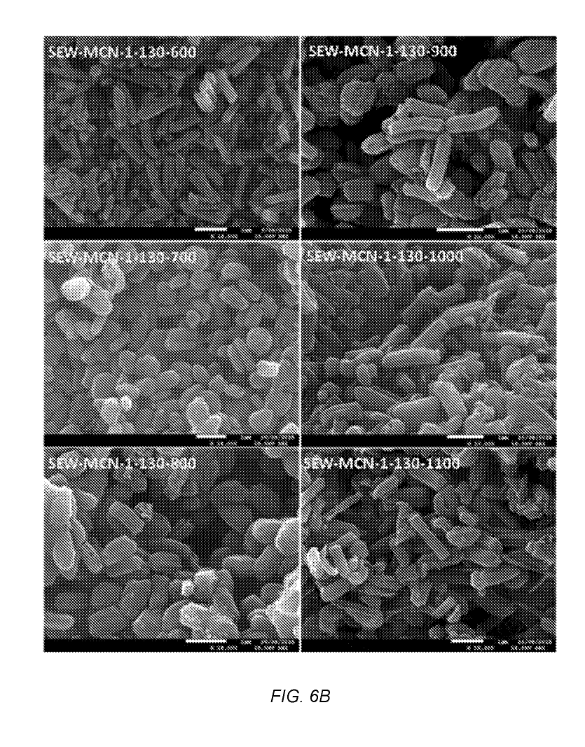

The morphology and surface topology of the SEW-MCN-1-T samples were investigated using HR-SEM and HR-TEM microscopy. HR-SEM were obtained using a JOEL Field emission FE SEM 7001. The operating voltage was 10 kV and a working distance of 10 mm was used. Prior to SEM imaging, the samples were coated with 5 nm layer of Pt using BALTEK Pt coater operating at 15 mA for 90 seconds. The HR-TEM images were taken using Tecnai F20 FEG TEM equipped with EDAX EDS and GIF (Gatan Image Filter). HR-TEM images were obtained using a JEOL-3100FEF (JOEL, U.S.A.) high-resolution transmission electron microscope. The preparation of the samples for HR-TEM analysis involved sonication in ethanol for 5 min and deposition on a copper grid. The accelerating voltage of the electron beam was 200 kV. As noted earlier, morphology has a direct bearing on the textural properties of the materials, which in turn determines the CO₂ adsorption property of the materials. FIG. 6A(a-c) shows the HR-SEM images of the SEW-SBA-15-X samples 1-3 and FIG. 6A(d-e) shows the HR-SEM images of the corresponding carbon nitride obtained by the replication process (samples 4-6). FIG. 6B shows the HR-SEM images of the SEW-MCN-1-130-T samples 7-12. Referring to FIG. 6A, it was determined that all the samples have distinct and uniform shaped particles. The rod shaped morphology results because of the static condition employed during the synthesis of the templates. However, the size of the single particles depended on the temperature of synthesis and consequently the three samples have rod shaped particles, but are of different sizes. From the FIG. 6A(d-e), it was determined that the rod shaped morphology of the silica template was successfully replicated into the corresponding rod shaped morphology of the carbon nitride particles. Since the templates had particles of different sizes, the same was replicated to the corresponding carbon nitride. Among the three samples, SEW-MCN-1-130 samples had particles of uniform length and neatly dispersed without any cross-linking. Referring to FIG. 6B, it was determined that the particle morphology was conserved even at higher carbonization temperature of 1100° C. Although the rod shaped morphology was retained at higher carbonization temperature, the particle size was not the same for all the samples. For example, in case of SEW-MCN-1-130-600/900/1000/1100 samples had long rod shaped particles whereas SEW-MCN-1-130-700/800 samples had much shorter and thick, but still rod shaped particles. The changes in the particle morphology were due to the carbonization temperature. The surface texture of the particles in each sample showed the presence of a large number of pores, which were believed to be generated at to higher carbonization temperature and contribute to the large specific surface and pore volumes exhibited by these samples.

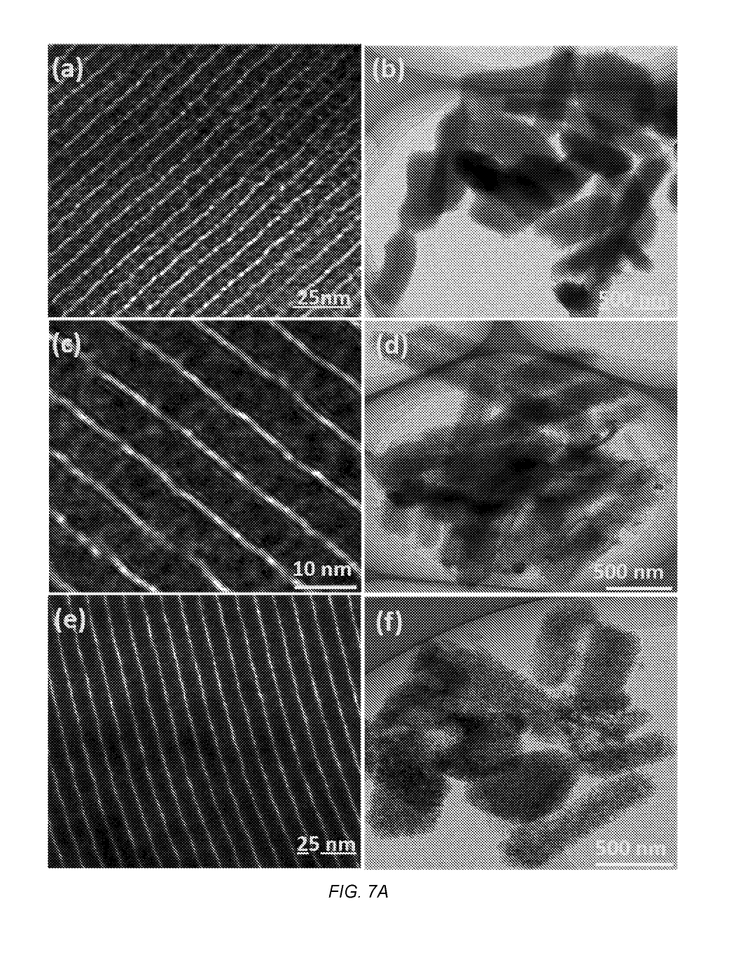

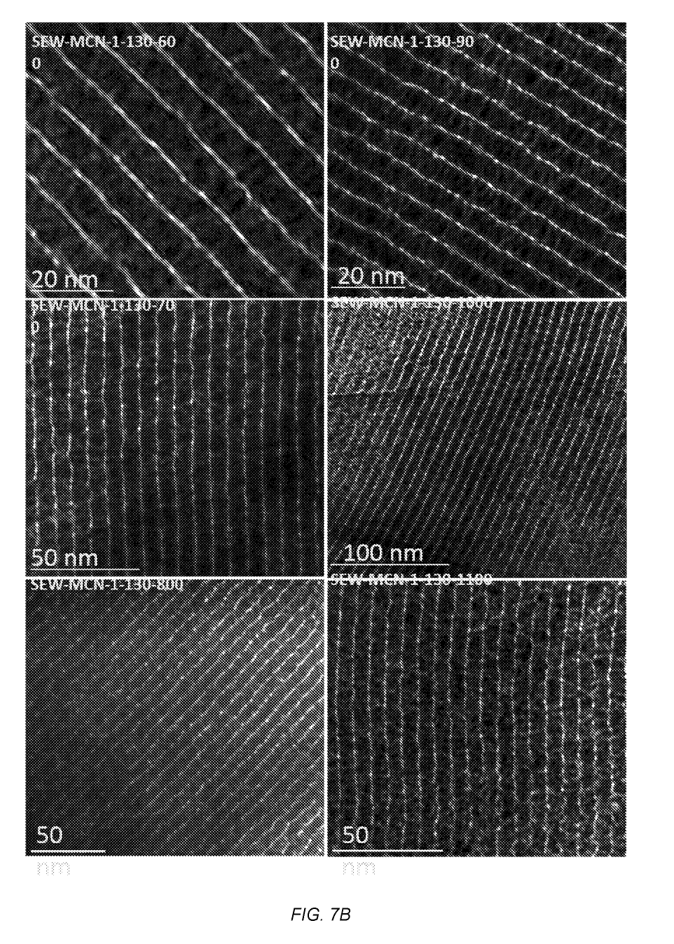

FIG. 7A(a-f) shows the low and high resolution TEM images of the SEW-MCN-1-X samples. All the three samples had well defined mesochannels running parallel to each other showing the presence of long range order, which was further supported by the XRD and N₂ adsorption-desorption results. The TEM images further confirmed the rod shaped morphology of the particles. Among the three samples, SEW-MCN-1-130 sample, however, had particles of uniform dimensions and long range and chemically well-defined mesostructure.

The mesoporosity in the SEW-MCN-1-130-T samples was investigated using HR-TEM. FIG. 7B shows the HR-TEM images of the SEW-MCN-130-600, -700, -800, -900, -1000, -1100 samples of the present invention. From the images, it was determined that all the samples exhibited parallel mesoporous channels confirming the presence of mesoporosity.

XPS and FTIR.

XPS spectra of the samples prepared using the methods of Example 1 and 2 was obtained using a Kratos Axis Ultra X-ray photoelectron spectrometer with a 20 kV, Al Kα probe beam (E=1486.6 eV). Prior to the analysis, the samples were evacuated at high vacuum (4×10−7 Pa), and then introduced into the analysis chamber. For narrow scans, analyzer pass energy of 20 eV with a step of 1 eV was applied. To account for the charging effect, all the spectra were referred to the C1s peak at 284.5 eV. Survey and multiregion spectra were recorded at C1s and N1s photoelectron peaks. Each spectral region of photoelectron interest was scanned several times to obtain a good signal-to-noise ratio.

FTIR spectra of the samples prepared using the methods of Example 1 and 2 was obtained using a Nicolet 5700 FTIR spectrometer fitted with a diamond attenuated total reflection (ATR) accessory that gives the data collection over the range of 7800 to 370 cm⁻¹. The spectra were recorded by averaging 200 scans with a resolution of 2 cm⁻¹, measuring in transmission mode.

The nature and coordination of the carbon and nitrogen atoms in the Examples 1 and 2 samples were analyzed using XPS and FTIR. The surface composition, nature and coordination of C and N in the samples was analyzed using XPS. In addition to the expected elements namely C, N and O, the survey spectrum also showed the presence of trace quantities of Si and F. The fluorine was attributed to the HF used for dissolving silica while the trace quantity of Si indicates that the silica removal may not be effective or even for all the samples. The elemental surface composition for different samples is show in Table 4. The three SEW-MCN-1-X-600 (X=100, 130, 150) samples primarily contained C and N with a trace amount of O as shown in Table 4. The absence of Si peak suggested that the silica framework removal by dilute HF was very effective in dissolving the entire silica framework to give silica-free MCN. The survey spectrum of all the three samples showed C, N and O at almost identical B.E. values indicating that these sample were chemically identical in terms of the surface distribution of C and N atoms. The traces quantity of O was ascribed to the ethanol wash step after silica removal with HF or from adsorption of atmospheric water vapor or CO₂.

TABLE 4

| Sample | | C | N | O | Si | F |
|---|---|---|---|---|---|---|
| No. | Sample Description | (%) | (%) | (%) | (%) | (%) |
| 4 | SEW-MCN-1-100-600 | 79.0 | 17.12 | 3.89 | — | — |
| 5 | SEW-MCN-1-130-600 | 79.32 | 17.74 | 2.94 | — | — |
| 6 | SEW-MCN-1-150-600 | 76.87 | 20.45 | 2.68 | — | — |
| 7 | SEW-MCN-1-130-600 | 80.71 | 16.17 | 2.74 | — | 0.39 |
| 8 | SEW-MCN-1-130-700 | 82.39 | 14.33 | 3.01 | 0.26 | — |
| 9 | SEW-MCN-1-130-800 | 86.22 | 10.35 | 3.43 | — | — |
| 10 | SEW-MCN-1-130-900 | 89.34 | 6.30 | 4.36 | — | — |
| 11 | SEW-MCN-1-130-1000 | 92.31 | 3.97 | 3.0 | 0.34 | 0.38 |
| 12 | SEW-MCN-1-130-1100 | 93.49 | 2.43 | 3.83 | 0.25 | — |

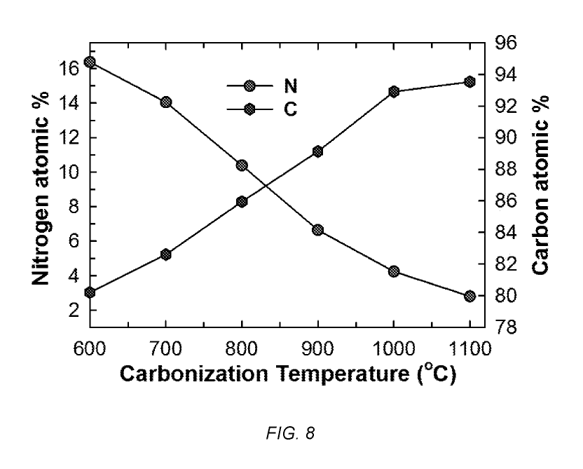

FIG. 8 shows the variation of C and N surface atomic composition with carbonization temperature. From the data, it was determined that a progressive increase in the C atomic % while a proportional decrease in the N atomic % with increasing carbonization temperature occurred. The two curves intersect at carbonization temperature between 800-900° C., about 850° C., from which the optimum C and N values was determined. From the XPS survey spectra, was determined that changing the carbonization temperature has a direct bearing on the quantity of N content which in turn affects the chemistry of N in the samples. In other words, the environment and chemistry of N in the samples changed drastically with changing carbonization temperature and the same was investigated through high resolution N1s spectra of these samples.

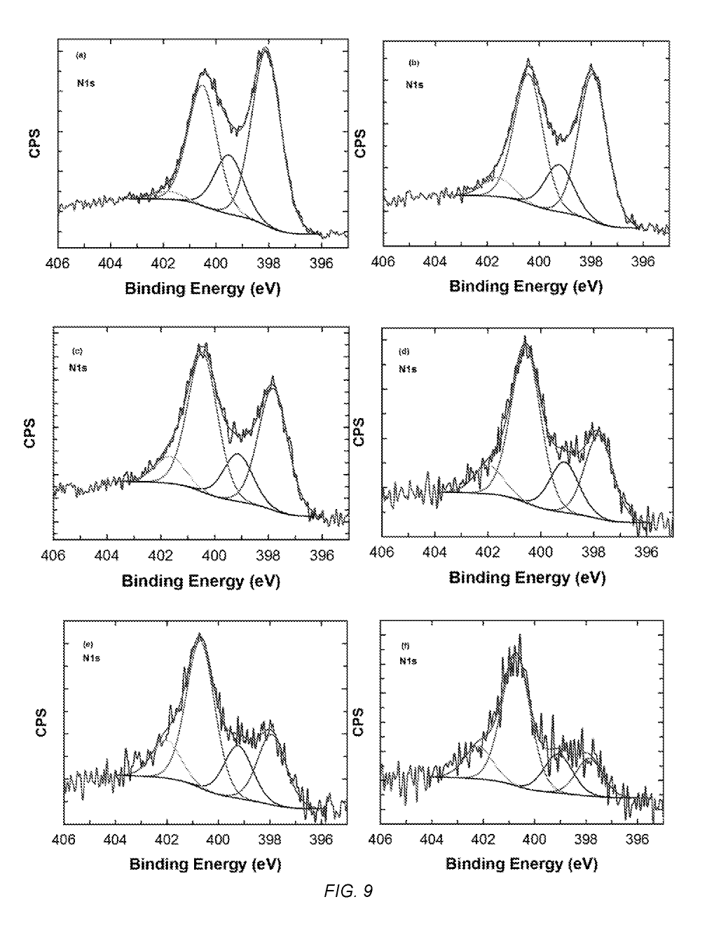

FIG. 9(a-f) shows the curve-fitted N1s spectra for the SEW-MCN-1-130-T samples. All spectra were calibrated using the Graphitic C1s at 284.4 eV. The samples of the present invention showed similar spectra. The four N components present were consistent with the following N species ˜398 eV sp² N atoms bonded to C atoms in aromatic rings i.e. pyridinic, ˜399.2 eV N atoms in an amide (O═C—NH₂) group ˜400.5 eV N atoms trigonally bonded to three C atoms and 401.5 eV quaternary N⁺. Having cross correlation with the same groups present in the fitted C1s and O1s spectra gave credibility to the result of the curve fitting e.g. conformation of the presence of amides can be found in the Ols species at ˜531.5 eV and a C1s species at ˜288.4 eV, both with similar concentration to the that of the amide N. The well-defined various N1s species was used to establish what happened during heating. It was determined that a reduction in the pyridinic N species (˜399.2 eV) with a corresponding increase in the N trigonally bonded to three C atoms (˜400.5 eV). There appeared to be a constant level of amide N.

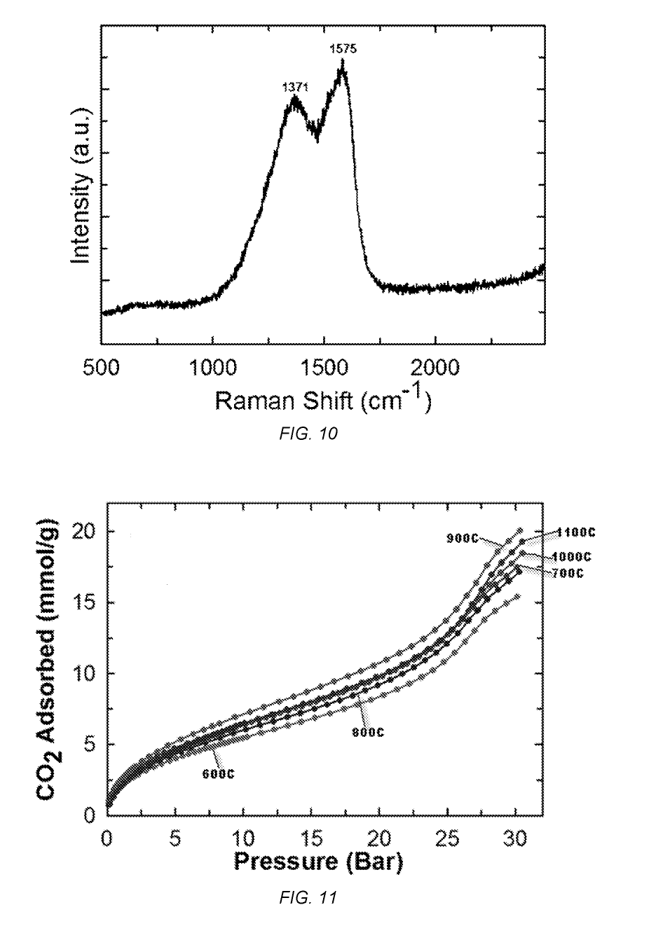

Raman spectrum of only SEW-MCN-1-130-600 sample was obtained on a Renishaw in Via Raman microscope using the 514 nm argon green laser with a dwell time of 30 seconds, accumulation 1 and power consumption of 0.1 mw. The procedure involves placing a tiny quantity of powder sample inside the analysis chamber after which the laser beam is turned ON for a fixed time duration and spectra is recorded. FIG. 10 shows the spectrum of SEW-MCN-1-130-600 sample. The samples of the present invention showed similar spectra. The Raman spectrum shows two distinct and intense bands at 1371 cm⁻¹ 1575 cm⁻¹, which were attributed to the D (disordered) and G (graphitic) bands of the sp². hybridized based carbon. The relative intensities of the G and D bands were a measure of the degree of graphitization of the SEW-MCN-1-130-600 sample. The existence of D band signified that presence of disordered graphitic carbons in the wall of the materials. The relative intensities of D and G band showed that there was a high degree of graphitization in the SEW-MCN-1-130-600 structure. From this result, it was concluded that the pore wall was composed of a large number of sp²-hybridized C species.

### Example 4

### High Pressure CO₂ Adsorption-Effect of Carbonization Temperature

The CO₂ adsorption capacity of the MCN materials with different nitrogen content was evaluated at different analysis temperatures of 0, 10 and 25° C. and pressure range of 0-30 bar (0 MPa to 3 MPa). As discussed earlier, MCNs have large number of free —NH and —NH₂ groups which can act to anchor the slightly acidic molecule CO₂. Without wishing to be bound by theory, it is believed that MCNs with regular morphology facilitates access to the active sites and enhances inter-particle diffusion besides affecting the textural properties of the adsorbent material.

SEW-MCN-1-130-T samples with surface areas of 655 to 781 m²/g, a surface nitrogen content varying from 16.17 to 2.43%, and a uniform rod shaped morphology were found to be excellent adsorbents for CO₂ uptake. FIG. 11 shows the CO₂ adsorption isotherms for the SEW-MCN-1-130-T samples at 273 K (about 0° C.) and up to 30 bar (3 MPa) pressure. From the isotherms, it was determined that the sample carbonized at 900° C. recorded the highest CO₂ adsorption capacity of 20.1 mmol/g compared to other samples. Table 2 shows the CO₂ adsorption capacities of different samples. The highest CO₂ adsorption capacity of SEW-MCN-1-130-900 sample was attributed to its optimum surface area and nitrogen content

From, comparison of the textural properties (Table 2) and nitrogen content of the samples (Table 4) and the corresponding CO₂ adsorption capacities it was determined that not the highest surface area or highest nitrogen content alone that dictated the overall CO₂ adsorption capacity of a material, but an interplay between surface area and nitrogen content. Thus, a sample (e.g., SEW-MCN-1-130-900 sample) with optimum surface area and nitrogen content recorded the highest CO₂ adsorption. This observation was also supported and further reinforced by the XPS analysis.

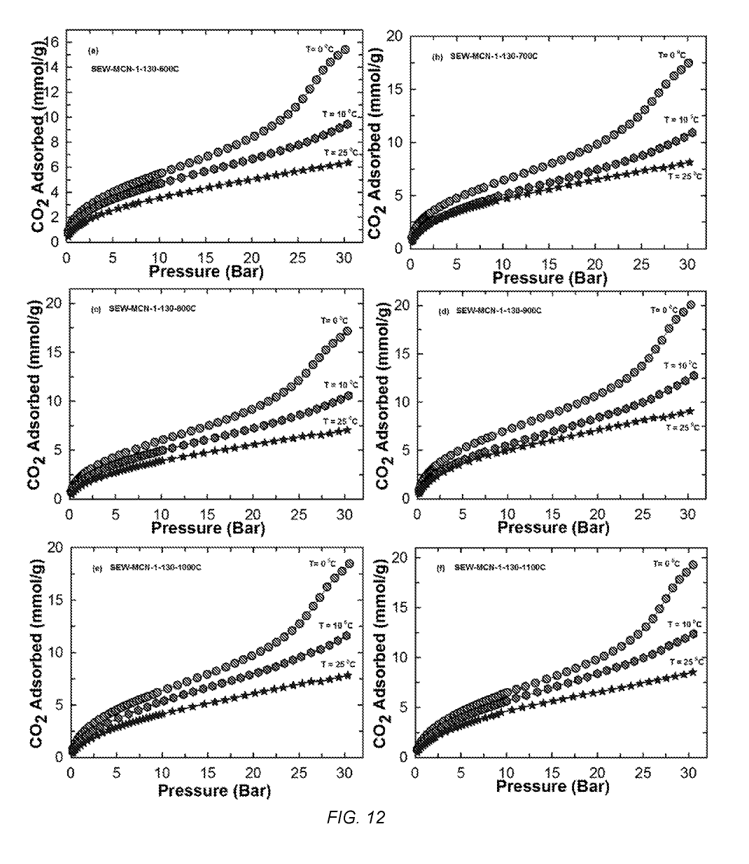

The effect of temperature on the CO₂ adsorption was investigated by recording the adsorption isotherms for each sample at three different temperatures 0, 10 and 25° C. and pressure up to 30 bar (3 MPa). FIG. 12 (a-f) shows the adsorption isotherms for each sample recorded at three different temperatures. FIG. 12(a) for SEW-MCN-1-130-600° C., 12(b) for SEW-MCN-1-130-700° C., 12(c) for SEW-MCN-1-130-800° C., 12(d) for SEW-MCN-1-130-900° C., 12(e) for SEW-MCN-1-130-1000° C., 12(f) for SEW-MCN-1-130-1100° C. Table 5 shows CO₂ adsorption capacities of the samples at three different temperatures. It is clear from the adsorption capacities that as the adsorption temperature increased from 0 to 25° C., the adsorption quantity decreased. From this data, it was determined that the adsorption process was exothermic in nature and was favored at lower adsorption temperatures. Mathematically, the CO₂ adsorption isotherms represented strictly monotonic increasing functions of pressure, which means as the pressure was increased, the quantity of CO₂ adsorbed also increased. Based on the above discussion, it was concluded that CO₂ adsorption by SEW-MCN-1-130-T samples were strongly affected by temperature and pressure conditions and low temperatures and higher pressures favor higher adsorption.

TABLE 5

| SAMPLE | SAMPLE | ^{a}CO₂ adsorption capacity (mmol/g) | | |
|---|---|---|---|---|
| NO. | DESCRIPTION | 0 (° C.) | 10 (° C.) | 25 (° C.) |
| 7 | SEW-MCN-1-130-600 | 15.4 | 9.43 | 6.38 |
| 8 | SEW-MCN-1-130-700 | 17.47 | 10.9 | 8.12 |
| 9 | SEW-MCN-1-130-800 | 17.15 | 10.56 | 7.05 |
| 10 | SEW-MCN-1-130-900 | 20.06 | 12.74 | 9.05 |
| 11 | SEW-MCN-1-130-1000 | 18.47 | 11.6 | 7.82 |
| 12 | SEW-MCN-1-130-1100 | 19.27 | 12.37 | 8.54 |

^{a}CO₂ adsorption using dry and pure CO₂ at 30 bar.

In general, the total amount of adsorbed CO₂ molecules depended mainly on the surface area, porosity, and pore volume of the mesoporous materials. The abundant presence of nitrogen surface groups of MCN materials was also responsible for the enhancement of CO₂ uptake. As discussed, the total amount of CO₂ uptake was higher for the MCN sample carbonized at 900° C. than for those synthesized at other temperatures, indicating that the types of quaternary nitrogen contributed to the improvement of CO₂ capture than pyridinic and pyrrolic functionalities at each adsorption temperature. It was demonstrated that incorporation of basic functionalities, especially quaternary structure inside the MCN matrix, improved the adsorption capacity of CO₂ with a soft acidic character at relatively low pressure and high temperature.

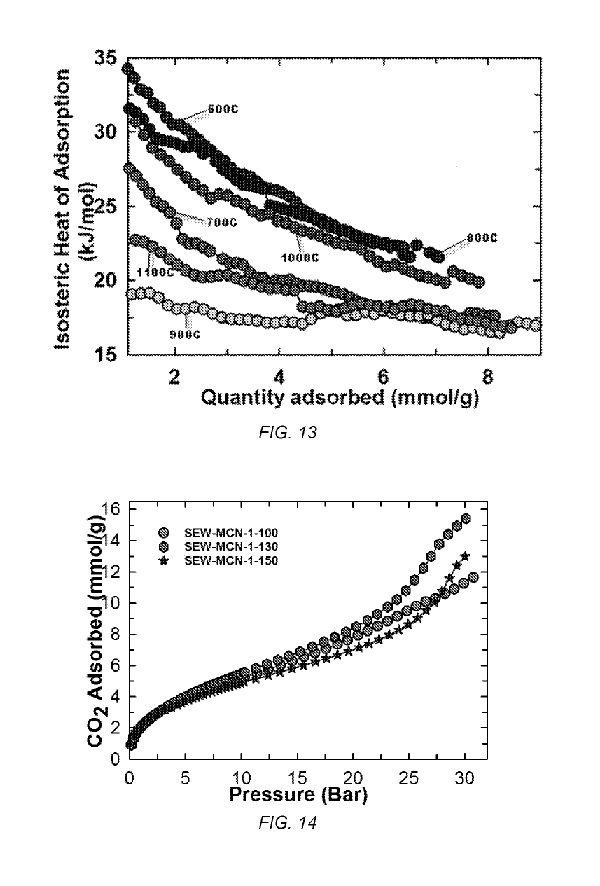

Furthermore, the strength of adsorbate-adsorbent interaction was investigated by calculating the isosteric heat of adsorption from the Clausius-Clapeyron equation using three isotherms recorded at 0, 10 and 25° C. for each sample as shown in FIG. 13 and values indicated in Table 5. FIG. 13 shows variation of isosteric heat of adsorption with CO₂ loading for SEW-MCN-1-130-X samples. It was determined, that the sample carbonized at 600 degree centigrade, which has the highest surface nitrogen content (Table 2) and lowest surface area and pore volume showed the highest isosteric heat of adsorption at lower CO₂ loading. In contrast, the sample that recorded the highest overall CO₂ adsorption showed the lowest isosteric heat of adsorption at lower CO₂ loading. Without wishing to be bound by theory, it is believed that the overall CO₂ adsorption was largely dictated by the porosity of the material (such as surface area, pore volume) and the surface nitrogen functions are mainly responsible for higher isosteric heat of adsorption at lower CO₂ loading. Thus, it is determined from this study that there was interplay between the textural properties and nitrogen density, and that CO₂ adsorption capacity was strongly influenced by textural parameters whereas nitrogen density dictated the strength of interaction between adsorbate and adsorbent. The materials were recycled and re-used several times and there was no visible loss of adsorption capacity. The materials were regenerated at heating it to 250° C. for about 6 hr under vacuum.

### Example 5

### High Pressure CO₂ Adsorption-Effect of Pore Diameter

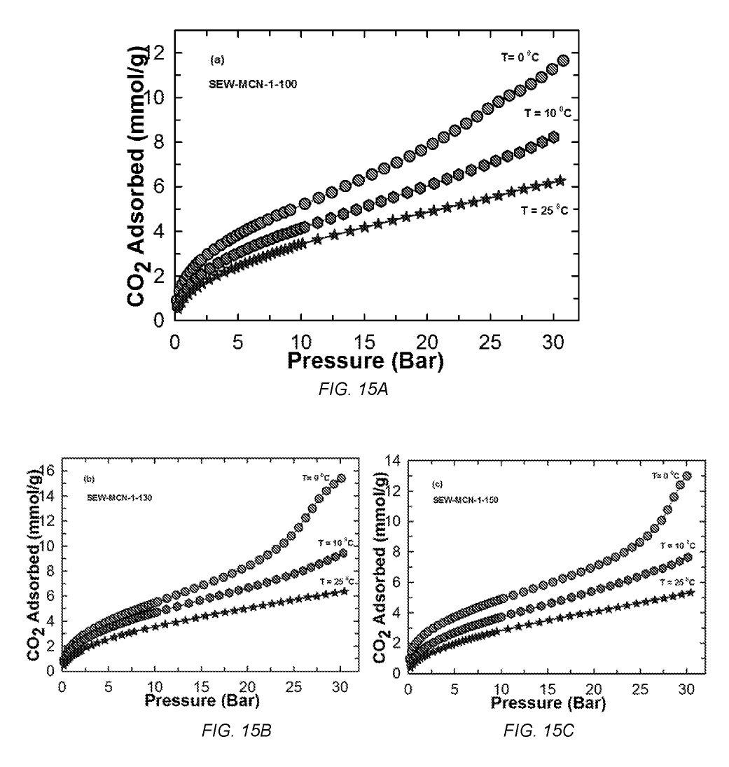

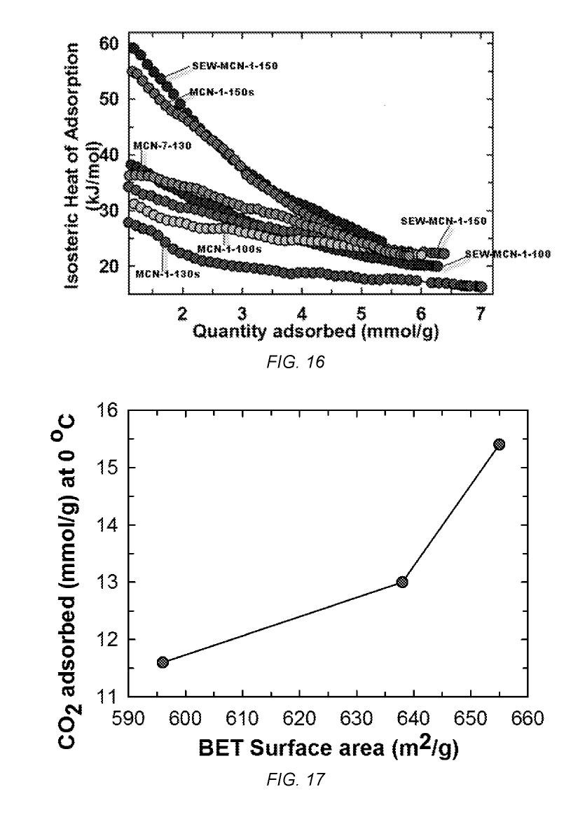

The materials prepared in this work were used as adsorbent at a very high pressure of up to 30 bar (3 MPa) and different temperatures 0, 10 and 25° C. FIG. 14 shows the CO₂ adsorption isotherms for SEW-MCN-1-X (X=100, 130 or 150° C.) samples recorded at about 0° C. Among the samples studied, SEW-MCN-1-130 registered the highest CO₂ adsorption capacity of 15.4 mmol/g at 0° C. and 30 bar (3 MPa), whereas SEW-MCN-1-100 and SEW-MCN-1-150 showed capacities of 11.6 and 13 mmol/g respectively under identical temperature and pressure conditions as summarized in Table 1. The SEW-MCN-1-130 (uncalcined SBA-15) showed identical CO₂ uptake behavior in comparison to its calcined counterpart MCN-1-130. However, from comparison of the CO₂ adsorption capacity of these two samples taking into consideration the energy and time aspects involved, there was no doubt that from commercial point of view, the SEW-MCN-1-130 was more cost and energy efficient. The SEW-MCN-1-X and MCN-1-Xs materials were similar from a structural, compositional and chemistry point of view with the exception of textural properties of the two materials since the method for removal of organic structure-directing agent does have a strong effect on the final textural properties of the materials. However, calcined samples MCN-1-Xs have better textural parameters as compared to ethanol washed materials and this difference is why the slightly reduced CO₂ adsorption capacity registered by SEW-MCN-1-X samples as compared to the calcined MCN-1-Xs. The effect of temperature on the adsorption capacity was evident from FIG. 15(a-c) and Table 6. FIG. 15 shows CO₂ adsorption isotherms of 15(a) SEW-MCN-1-100, 15(b) SEW-MCN-1-130, and 15(c) SEW-MCN-1-150. From the data in Table 6, it was determined that lower analysis temperature was favorable for higher CO₂ uptake. As the analysis temperature was increased, the CO₂ uptake behavior of materials decreased significantly, suggesting strong temperature dependence of adsorption capacity of these materials. The strength of interaction between the CO₂ adsorbate and MCN adsorbent was quantified in terms of the isosteric heat of adsorption. FIG. 16 shows the variation of isosteric heat of adsorption of SEW-MCN-1-T samples and their comparison with literature MCN-1-Xs samples and MCN-7-130. From FIG. 16, it was clear that among SEW-MCN-1-X samples, although SEW-MCN-1-130 showed higher CO₂ adsorption owing to its highest surface area, well defined structural order and uniform rod shaped morphology together with well-defined mesostructure, it was the SEW-MCN-1-150 samples, which showed higher isosteric heat of adsorption. In fact, in Table 7, SEW-MCN-1-150 had the highest isosteric heat of adsorption among the samples compared. The reason for the stronger adsorbent-adsorbate interaction and hence higher isosteric heat for SEW-MCN-1-150 was believed to be due to the availability of large pores in SEW-MCN-1-150 sample, which provided easy access to the CO₂ molecules. Further, N % per unit surface area was also highest for SEW-MCN-1-150 samples (about 3.2%) which facilitated multilayer CO₂ adsorption resulting in stronger adsorbate-adsorbent interaction.

It has been observed that materials with higher BET surface area and pore volume tended to exhibit higher CO₂ adsorption capacity when analysis temperature and adsorption pressure are kept the same as shown in FIG. 17. FIG. 17 shows the dependence of CO₂ adsorption capacity of SEW-MCN-1-X samples on the BET surface area of the materials. The ethanol washed SEW-MCN-1-X samples of the present invention also exhibited excellent recycling properties and did not give in to the enormous compressive forces resulting from high gas pressure used for adsorption applications. Besides, SEW-MCN-1-X samples of the present invention could be easily regenerated by applying controlled heating at 200-250° C. under vacuum for 6-10 h. From the data, it was determined that the rod-shaped uncalcined MCN materials of the present invention were easily synthesized without expending lot of energy and time and were a suitable adsorbent for CO₂ capture.

TABLE 6

| | | CO₂ adsorption capacity | | |
|---|---|---|---|---|
| | | (mmol/g) | | |
| Sample No. | Sample Description | 0° C. | 10° C. | 25° C. |
| 4 | SEW-MCN-1-100 | 11.6 | 8.2 | 6.2 |
| 5 | SEW-MCN-1-130 | 15.4 | 9.4 | 6.4 |
| 6 | SEW-MCN-1-150 | 13 | 7.6 | 5.3 |

TABLE 7

| | | Isosteric heat of |
|---|---|---|
| | | adsorption^{a} |
| Sample No. | Sample Description | (kJ/mol) |
| 4 | SEW-MCN-1-100 | 38.61 − 19.96 |
| 5 | SEW-MCN-1-130 | 34.44 − 22.21 |
| 7 | SEW-MCN-1-150 | 60.99 − 24.40 |
| 16 | MCN-1-100 | 31.1 − 22.0^{b} |
| 17 | MCN-1-130 | 27.9 − 16.3^{b} |
| 18 | MCN-1-150 | 54.9 − 22.3^{b} |
| 19 | MCN-7-130 | 34.9 − 24.0^{c} |

^{a}Isosteric heat of adsorption calculated from Clausius-Clapeyron equation using the isotherms recorded at 0, 10 and 25° C.
^{b}Lakhi et al., RSC Advs, 2015, DOI 10.1039/C5RA04730G
^{c}Lakhi et al. , Catalysis Today, 2015, 243, 209.

1. A method of producing a rod-shaped mesoporous carbon nitride (MCN) material, the method comprising:
(a) obtaining a template reactant mixture comprising an uncalcined rod-shaped SBA-15 template, a carbon source compound, and a nitrogen source compound;
(b) heating the reaction mixture at 80 to 100° C. to form a rod-shaped template carbon nitride composite;
(c) heating the rod-shaped template carbon nitride composite to a temperature of at least 500° C. to form a rod-shaped mesoporous carbon nitride material/SBA-15 (MCN-SBA-15) complex; and
(d) removing the SBA-15 template from the MCN-SABA-15 complex to produce a rod-shaped mesoporous carbon nitride material.

2. The method of claim 1 wherein the carbon source compound is carbon tetrachloride (CTC).

3. The method of claim 1, wherein the nitrogen source compound is ethylenediamine (EDA).

4. (canceled)

5. The method of claim 1, wherein template reaction mixture is heated at about 90° C.

6. (canceled)

7. The method of claim 1, wherein the heating step (c) is at a temperature of about 600 to 1100° C.

8. The method of claim 7, wherein the heating step (c) is at a temperature of about 900° C.

9. The method of claim 1, wherein the heating step (c) is performed under an inert gas flow.

10. The method of claim 9, wherein the nitrogen flow is at 40 to 60 mL per minute.

11. The method of claim 1, wherein the uncalcined rod-shaped SBA-15 template is prepared at a temperature is 100 to 150° C.

12. (canceled)

13. The method of claim 1, wherein the uncalcined rod-shaped SBA-15 template is prepared at a temperature of about 130° C.

14-15. (canceled)

16. The method of claim 1, wherein removing the uncalcined SBA-15 template is by contacting the mesoporous carbon nitride material/SBA-15 complex with a hydrofluoric acid solution.

17. The method of claim 1, further comprising producing a uncalcined rod-shaped SBA-15 template comprising the steps of:
(a) reacting a polymerization solution comprising amphiphilic triblock copolymer and tetraethyl orthosilicate (TEOS) at a predetermined reaction temperature to form a SBA-15 template, wherein the predetermined reaction temperature determines the pore size of the SBA-15 template;
(b) extracting the amphiphilic triblock copolymer with ethanol at room temperature; and
(c) drying the SBA-15 template to form an uncalcined SBA-15 template.

18. A carbon dioxide sequestration process comprising:
contacting the mesoporous carbon nitride material produced by the method of claim 1 and with a carbon dioxide containing fluid or gas; and
absorbing the CO₂,
wherein the mesoporous carbon nitride material is rod shaped and has a BET surface area of 650 to 790 m³g⁻¹.

19. The process of claim 18, wherein the process is performed at a temperature of 0 to 30° C.

20. The process of claim 18, wherein the process is performed at a pressure from 0.1 to 3 MPa.

21. The process of claim 13, wherein the mesoporous carbon nitride also has a pore diameter of 4.0 to 4.5 nm, a pore volume of 0.7 to 1.5 cm³g⁻¹, and a surface nitrogen content of 2.5 to 17.0% as determined by N₂ adsorption-desorption.
